(19) United States
(12) Patent Application Publication
(10) Pub. No.: US 2003/0190593 A1
(43) Pub. Date: Oct. 9, 2003

(54) Systems and methods for the automated generation of individual transition plans

(76) Inventors: Dennis E. Wisnosky, Naperville, IL (US); Philip J. Vitkus, Aurora, IL (US); Thadeus Letnes, Naperville, IL (US); John Conway, Westmont, IL (US)

Correspondence Address: Robert A. Brown, P.O. Box 2127, Northbrook, IL, 60065-2127, US

(21) Appl. No.: 10/404,802

(22) Filed: Apr. 1, 2003

Related U.S. Application Data
(60) Provisional application No. 60/370,588, filed on Apr. 5, 2002.

(51) Int. Cl. G09B 7/00

(52) U.S. Cl. 434/362

(57) ABSTRACT

A system and methods for the automated generation of individual transition plans while maintaining a knowledge base that is accessible by all participating individuals as the plan is executed and managed. A computer database receives a student's post school goals, receives the student's present levels of performance, determines the student's transition services needed to achieve the post school goals, and generates an individual transition plan. The individual transition plan is also periodically updated upon any changes in the individual's present levels of performance. The system is accessible by an internet site for individuals participating in the individual transition plan to permit information in the system to be exchanged with and between authorized users. The system may also include security that permits access to certain areas of the system by authorized users. A plurality of system services, a plurality of work areas and a plurality of application services on the system are accessible by authorized users. Related methods are also disclosed.

### CROSS-REFERENCE TO RELATED APPLICATION

This patent application claims priority from U.S. provisional application Serial No. 60/370,588, filed on Apr. 5, 2002, the entire contents of which are hereby incorporated by reference herein.

### BACKGROUND OF THE INVENTION

The present invention relates generally to systems and methods for measuring educational performance levels, and more particularly to methods and systems for determining students' post school goals, present levels of performance, transition service needs, needed transition services and for automatically generating an individual transition plan while maintaining a knowledge base which is used by all participating individuals as the plan is executed and managed.

Old methods have the Transition Planning process carried out entirely manually or by using the computer only as a data repository and printer. As such the process is random and idiosyncratic. No parsable data is gathered which allows the process to be analyzed and improved over time either manually or automatically. Records are kept in variable and often slipshod forms and methods. There are no standard links to services able to be provided within the educational environment or from the community. Every individual involved in the process takes his or her own approach. When Individuals move to a different school system, the process begins anew.

Prior art methods of performing Transition Planning, Execution and Management are inherently unreliable, slow and fraught with human error that is often not discovered until years later in the Individuals' lives. Further, they are difficult to replicate because they are manual. This results in the inability to find out what went wrong, and therefore the opportunity and likelihood of repeating past mistakes is increased. From the point of view of compliance with local, state and Federal laws and regulations, prior art methods maintain no accepted standards of Performance or the ability for their uniform application if these standards did exist. It can be asserted that these old methods cannot be performed in a manner that complies with applicable laws and regulations.

Within the educational system, intellectual capital is widely dispersed by organization and geography. Fast moving and varied laws, regulations and technologies force school systems to manage more with less. Finding the right people, skills and resources for successful Transition Planning, Execution and Management requires precision tools. There is frequently poor communication. As a result, IEP teams, which perform Transition Planning, Execution and Management, are constantly re-inventing what has been done with limited or no structure to business processes, and no visibility of best practices, because they are owned by isolated groups, and have no means to collaborate with non co-located team members.

The time horizons and accuracy required for Transition Planning, Execution and Management continue to decrease while expectations continue to increase. Constantly shifting government priorities, lack of necessary skilled personnel, transience of the population, decreasing availability of funds and other factors have caused a situation where it is literally impossible to manually comply with all Transition Process requirements on a continuous basis with the prior art techniques.

Educators, Administrators, Case Managers, Counselors, Service Providers and Parents must combine the long-term strategic view with the entrepreneurial ability to turn on a dime. The great disparity in the size and number of geographically dispersed participants and the increased number of viewpoints which must be considered in Transition Planning, Execution and Management could be referred to as “elephants dancing with mosquitoes.” According to Harris and Associates, consequences of this situation are:

Less than one-third of Americans with disabilities between the ages of 18 and 64 are working full or part-time.

The poverty rate is higher for Americans with disabilities.

Twenty-nine percent of persons with disabilities are living on household incomes of less than $15,000 per year compared to ten percent of the non-disabled population.

Study of the root causes of these failures leads to the conclusion that most Individuals really had little chance to achieve even their minimum expected level of Performance. There are clear and obvious reasons for this, and they are correctable through application of the present invention. For example: The people selected to perform the Transition Planning, Execution and Management were not up to the Task, the Individuals would not accept results achieved, the results could not be achieved with state of the art knowledge, preference goals were not properly translated into a measurable set of objectives with a well defined set of metrics that could be tracked and used to control the program, and so forth. In other words, the prior art manual process was out of control from its inception. No one knew this, or requirement was piled upon requirement until the process collapsed under its own weight.

There is therefore a need for automated systems and methods for measuring performance levels of students.

There is also a need for automated systems and methods for generating an individual transition plan for a student that takes into account post school goals, present levels of performance and available transition services and resources.

### SUMMARY OF THE INVENTION

In general, the present invention is concerned with a system for the automated generation of individual transition plans that are based upon current performance levels, post school goals and available transition services and resources, to assist in achieving the post school goals. The present invention also contemplates maintaining a knowledge base that is accessible to all participating individuals as the plan is being executed and managed.

A computer database receives a student's post school goals, receives the student's present levels of performance, determines the student's transition services needed to achieve the post school goals, and generates an individual transition plan aimed at achieving the post school goals. From time to time, the student's progress is analyzed by the computer database against the individual transition plan and an updated individual transition plan is generated.

The system is preferably accessible by an internet site for most individuals participating in the individual transition plan. A computer database in the system communicates with the internet site to permit information to flow between the database and the individuals participating in the individual transition plan, such as authorized users. The system may also include a security level that only permits authorized users to have access to said system. In addition, some users of the system may not have access to all areas of the system, while managers may have expanded access to certain areas of the system.

The system includes a plurality of system services that are accessible by authorized users. For example, the plurality of system services may include user management, system search, group/tenant management, security management, area management, web drive and wireless management. The system also includes a plurality of system work areas that are accessible by authorized users. For example, the plurality of system work areas may include enterprise areas, individual areas, user areas and experience areas. In addition, a manager's layer permits access of certain information in the plurality of system work areas only by authorized managers, such as managers of knowledge, managers of teams, managers of process and managers of risk. A plurality of application services are accessible by authorized users. For example, the plurality of application services may include calendaring, Gantt charts, Email, surveys, discussion groups, a personal assistant, version control, work flow, computer based training, lessons learned, individual planning, peer-to-peer messaging, report builder, instant alerts, web agent and experiences.

The present invention also includes methods for the automated generation of individual transition plans in a system that includes a computer database. The methods include receiving a student's post school goals into the system; receiving the student's present levels of performance into the system; automatically determining the transition services needed by the student to achieve the post school goals; and automatically generating an individual transition plan for said student. The methods further include analyzing the student's progress within the system against the individual transition plan; and periodically generating an updated individual transition plan within the system.

The methods also include providing internet site access to the system for individuals participating in the individual transition plan; and communicating between the internet site and the computer database to permit information to flow between said database and the individuals participating in the individual transition plan. In addition, security levels may be used to permit only authorized users to have access to the system.

The methods of the present invention also contemplate providing a plurality of system services on the system that are accessible by authorized users, such as user management, system search, group/tenant management, security management, area management, web drive and wireless management. The methods further provide a plurality of system work areas on the system that are accessible by authorized users, such as enterprise areas, individual areas, user areas and experience areas. The methods also provide a manager's layer on said system that permits access of certain information in the plurality of system work areas only by authorized managers, such as managers of knowledge, managers of teams, managers of process and managers of risk. The methods also provide a plurality of application services on the system that are accessible by authorized users, such as calendaring, Gantt charts, Email, surveys, discussion groups, personal assistant, version control, work flow, computer based training, lessons learned, individual planning, peer-to-peer messaging, report builder, instant alerts, web agent and experiences.

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the several Figures in which like reference numerals identify like elements, and in which:

FIG. 1 is a high level flow chart illustrating the planning, execution and management of an individual educational plan in the context of a computer database system that also integrates resources, schedules, assets and risks in accordance with the present invention;

FIG. 2 is a diagram showing the notional concept of Transition Planning, Process and Knowledge Management integration;

FIG. 3 is a diagrammatic illustration showing a typical home page at an internet site that serves as an entry point to the system and methods of the present invention;

FIG. 4 is a general illustration in the form of a high-level diagram of the software components that are used for integrating resources, schedule, assets and risk in accordance with the present invention;

FIG. 5 is a diagrammatic view of the security employed during internet access by a user seeking to gain access to the system;

FIG. 6 is a diagrammatic view of typical services that may be available in different areas of the system;

FIG. 6A is a diagrammatic view of the management of authorized users of the system via the internet;

FIG. 6B is a diagrammatic view of a user requesting a search of information via the internet in the system, and obtaining search results;

FIG. 6C is a diagrammatic view of the use of the system via the internet when users are placed in distinct groups;

FIG. 6D is a diagrammatic view of the setting of security for different types of users seeking to gain access via the internet to different areas of the system;

FIG. 6E is a diagrammatic view of the management of different areas of the system relative to an internet user;

FIG. 6F is a diagrammatic view of automated access to the system via the internet through the Web Drive service;

FIG. 6G is a diagrammatic view of a user accessing the system to send and receive messages via the internet with a wireless application protocol (WAP) device;

FIG. 7 is a diagrammatic view showing how the system work areas are subdivided into enterprise, personal, individual and experience areas;

FIG. 8 is a diagrammatic view of the management of knowledge, teams, processes and risks in the system by respective managers of knowledge, team, process and risk via the internet;

FIG. 9 is a diagrammatic view showing many application services that various users of the system may employ to accomplish particular methods;

FIG. 9A is a diagrammatic view showing the various ways in which the Calendaring application may be used via the internet;

FIG. 9B is a diagrammatic view showing the various ways in which the Gantt Chart application may be used via the internet;

FIG. 9C is a diagrammatic view showing the various ways in which the Email application may be used via the internet;

FIG. 9D is a diagrammatic view showing the various ways in which the Surveys application may be used via the internet;

FIG. 9E is a diagrammatic view showing the various ways in which the Discussion Groups application may be used via the internet;

FIG. 9F is a diagrammatic view showing the various ways in which the Personal Assistant application may be used via the internet;

FIG. 9G is a diagrammatic view showing the various ways in which the Version Control application may be used via the internet;

FIG. 9H is a diagrammatic view showing the various ways in which the Work Flow application may be used via the internet;

FIG. 9I is a diagrammatic view showing the various ways in which the Computer Based Training application may be used via the internet;;

FIG. 9J is a diagrammatic view showing the various ways in which the Individual Planning application may be used via the internet;

FIG. 9K is a diagrammatic view showing the various ways in which the Lessons Learned application may be used via the internet;

FIG. 9L is a diagrammatic view showing the various ways in which the Peer to Peer application may be used via the internet;

FIG. 9M is a diagrammatic view showing the various ways in which the Report Builder application may be used via the internet;

FIG. 9N is a diagrammatic view showing the various ways in which the Instant Alerts application may be used via the internet;

FIG. 9O is a diagrammatic view showing the various ways in which the Web Agent application may be used via the internet;

FIG. 9P is a diagrammatic view showing the various ways in which the Messaging application may be used via the internet;

FIG. 9Q is a diagrammatic view showing the various ways in which the Repository application may be used via the internet; and

FIG. 9R is a diagrammatic view showing the various ways in which the System Database application may be used via the internet.

### DETAILED DESCRIPTION OF THE INVENTION

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of the Invention”) relates to a requirement of the United States Patent and Trademark Office, and should not be found to be limiting to the subject matter disclosed and claimed herein.

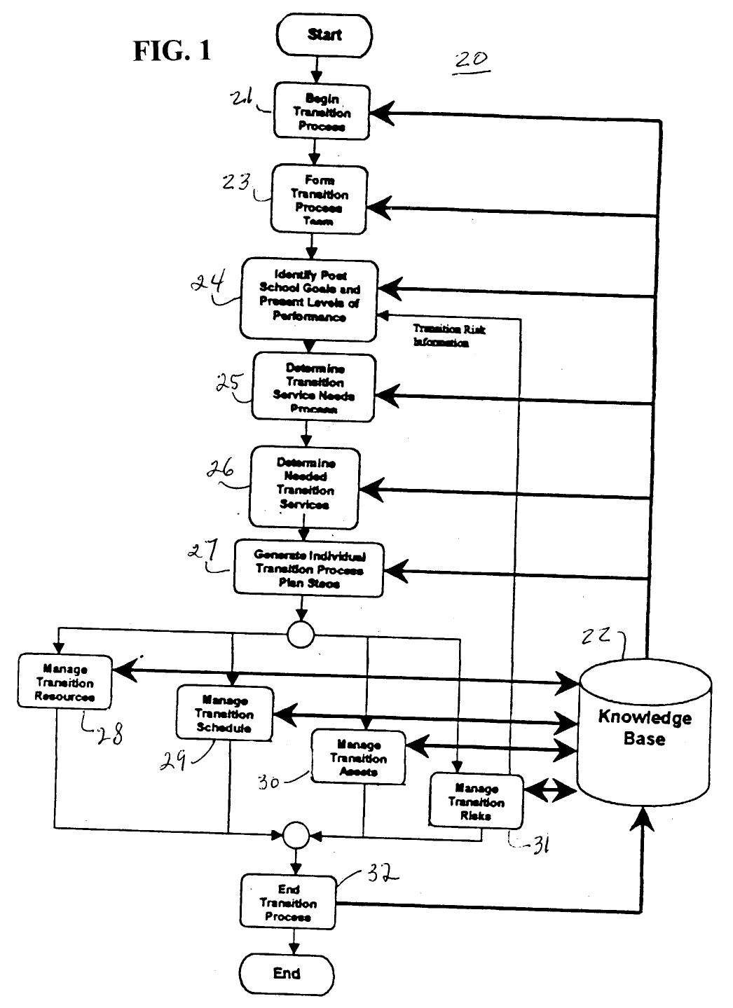

This invention integrates three bodies of thought, Risk, Process and Knowledge Management, heretofore considered to be independent, into a practical Method and System, which is generally illustrated in FIG. 1, and which collectively interact in a way that synergistically multiplies the effects of each upon the other, while at the same time enabling the benefits of any or each of the three to be independently realized at the choice of the user.

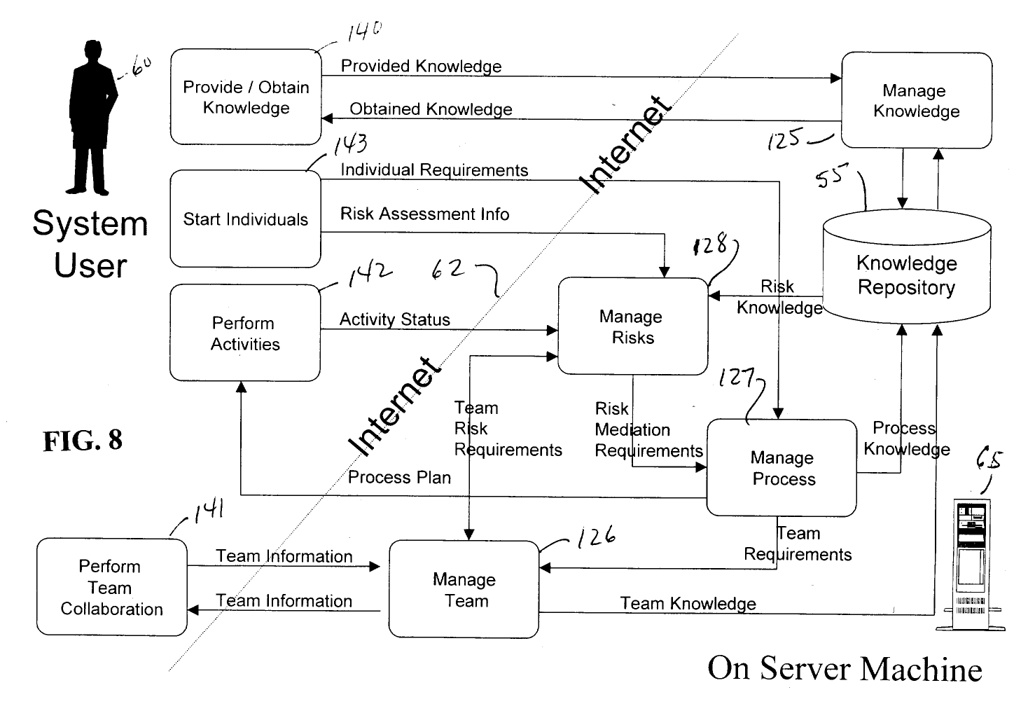

Referring to the drawings, including FIGS. 1 through 9R, there is shown in detail the novel and unobvious elements of the invention. The next 11 paragraphs describe the operation of the automated individual transition planning, execution and management block diagram, generally designated 20, in FIG. 1. Many of the elements of the methods and system presented in FIG. 1 are discussed in greater depth below and with reference to the other drawing FIGS. 1A-9R.

Begin Transition Process in block 21. The Transition Process 21 includes transition planning, execution, and management. Use of the present invention typically begins during the school year when a student with one or more disabilities turns 14, or sooner, depending upon the Individual Education Program (IEP) Team. The present invention extracts information from a Knowledge Base 22, using Email and Alerts to prompt and initiate the Transition Process 21. Knowledge Base 22 may be any suitable computer database, including one or more servers or the like.

Form Transition Process Team in block 23. The Transition Process team is developed over time and as the needs, goals, preferences of the students are developed. Special education case managers (or other school personnel responsible for overseeing the student's educational progress), in conjunction with the students with disabilities and/or their parent(s)/guardian(s), use the Knowledge Base 22 components of the present invention to explore, research, and identify potential additions to the Transition Process team, and the E-mail and Instant Alerts and other Application Services to communicate, using the Knowledge Manager (Email, Instant Alerts, Messaging, Calendaring, and Discussion Application Services) components to potential members of the Transition Process team. After communications, meetings and consensus among the Transition Process team members, the case managers use the System Services (User Management and Group-Tenant Management) Process Manager (Gantt Chart and Work Flow Application Services) and Team Manager components of the present invention to identify, solidify, and electronically document commitments by specific school personnel, student family members, and community service providers to provide specific supports and services to help make progress towards the student's post-secondary education, employment, and community living alternatives goals. As needed throughout the Transition Process, the case managers and other school and community personnel can take training on following the process correctly by accessing the Knowledge Manager (Computer Based Training and Personal [Electronic] Assistant Application Services) components of the present invention.

Identify Post School Goals and Present Levels of Performance in block 24. Using the Risk Manager (Survey Application Services) component of the present invention, the case manager member of the Transition Process team conducts one or more interviews with the students and/or their parent(s)/guardian(s), and records and electronically stores the student's with disabilities post-secondary goals, preferences, vision, needs, and strengths, such as on the Knowledge Base 22. In addition, using the Risk Manager (Survey Application Services) component, the case manager records and stores information about functional skill needs, obstacles to, supports and services needed to achieve post-secondary education, employment, and community living alternatives.

Determine Transition Service Needs in block 25. Using the Risk Manager (Survey Applications Services) and Process Manager (Individual Planning Applications Services) components of the present invention, the case manager automatically identifies general transition service needs, which are displayed through the Process Manager (Gantt Chart), stored in the Knowledge Base 22 and reportable though the Knowledge Manager (Report Builder Application Services) component of the present invention.

Determine Needed Transition Services in block 26. Using the Risk Manager (Survey Applications Services) and Process Manager (Individual Planning Applications Services) components of the present invention, the case manager automatically identifies specific needed transition services, which are displayed through the Process Manager (Gantt Chart), stored in the Knowledge Base 22 and reportable though the Knowledge Manager (Report Builder Application Services) component of the present invention.

Generate Individual Transition Process Plan Steps in block 27. Using the Process Manager (Gantt Chart, Work Flow Application Services) component of the present invention, the case manager uses the present invention to automatically extract from the Knowledge Base 22 the transition services and supports needed to achieve the student's post-secondary goals, including identifying community resources that are available and potentially available to assist the school system, parents, and students in meeting these goals. The needed services and supports are organized and displayed (Gantt Chart, Work Flow) and reportable through the Knowledge Management (Report Builder Application Services) component of the present invention. The needed services and supports are displayed in conjunction with the Knowledge Base 22.

Manage Transition Resources in block 28. Using the Team Manager and Process Managers component of the present invention, the case manager finalizes the electronic version of the transition plan, and assigns individuals to support progress towards the post-secondary goals. This includes utilizing the Gantt Chart Application Services, and the User Management and Group-Tenant Management System Services. This information is stored in the Knowledge Base 22 component of the present invention.

Manage Transition Schedule in block 29. Using the Team Manager and Process Managers components of the present invention, after finalizing the electronic version of the transition plan the case manager monitors and communicates with the individuals supporting progress towards the post-secondary goals. This includes utilizing the Calendaring, Discussion, Instant Alerts, Email, and Messaging Application Services. This information is stored in the Knowledge Base 22 component of the present invention.

Manage Transition Assets in block 30. Throughout the execution phase of the transition plan, the present invention manages all assets—documents and other files—created through communications, including status reports, of all members of the Transition Process Team. These assets are available as individual files through the Knowledge Base 22 as well as through the Knowledge Management (Report Builder and Lessons Learned) component of the present invention.

Manage Transition Risks in block 31. Throughout the execution phase, as well as in formal annual reviews, the preferences, goals, and vision of the student, as well as progress towards the goals, are periodically reviewed by the student and reviewed and updated by all members of the Transition Process team. The members of the Transition Process team can access this information through the Risk Manager and Process Manager components of the present invention.

End Transition Process in block 32. Upon completion of high school, the transition process ends. Student assets are stored and available as required and needed by adult service providers (including post-secondary school personnel), the student, and the student's family. The information is stored in the Knowledge Base 22 and available through the Reporting Application Services.

In summary, the flow chart of FIG. 1 permits a typical user of the Method and System for Transition Risk, Process and Knowledge Management integration to Begin Transition Process, Form Transition Process Team, Assess Initial Transition Process, Generate Transition Process Steps—each in linear sequence or independently, or in any sequence with respect to each or any of these choices, the user can Manage Resources (defined as those Individuals or service providers assigned to work on a Transition Plan), Manage Schedule (defined as the time assigned to each procedure or step in the process), Manage Assets (defined as that information and knowledge necessary to either or both know how to perform each procedure or step in the process and that information and knowledge acquired in Performance of each, any and all steps in the process, all of which is continuously updated and maintained in the Transition Process Knowledge Repository and Data Base. Risks, associated with performing the process steps collectively as a function of initially identifying skills necessary to accomplish the Individuals Performance goals, the steps themselves and adherence to the plan, are managed both through interaction with the user, as the system learns from experience in conducting various Projects.

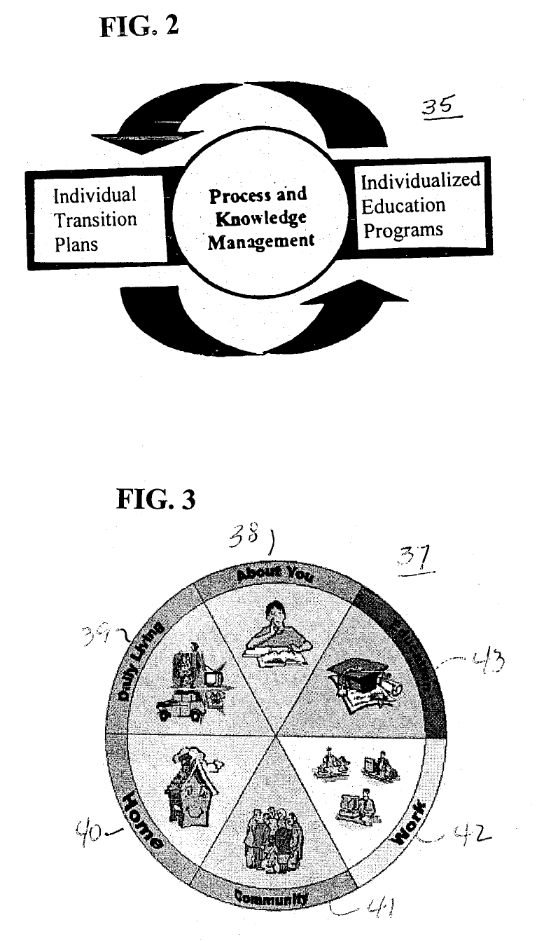

Thus, as illustrated in the diagram, generally designated 35 in FIG. 2, Process and Knowledge Management are used in accordance with the present invention to develop Individual Transition Plans within the context of Individualized Education Programs.

FIG. 3 illustrates one embodiment of an entry page, generally designated 37, which is representative of a home page at an internet website, and which may be the focal or starting point for completing the work of Individuals (Students, Parents, Executives, Administrators, Case Managers, Counselors, Consultants, Experts, Service Providers, and the like) and of Teams to perform the Transition Planning, Execution and Management process inherent within, but not limited to an Individualized Education Program (IEP). In the example of FIG. 3, the design may contain segments captioned About You 38, Daily Living 39, Home 40, Community 41, Work 42 and Education 43.

This home page 37 reminds the user of his/her immediate and future responsibilities through such features as displaying instant messages, future calendar events and access to system features including knowledge Assets, discussions and the system desktop for entry to specific process and risk management work areas with access to all system capability and features and software components that are used for integrating Knowledge, Team, Process and Risk.

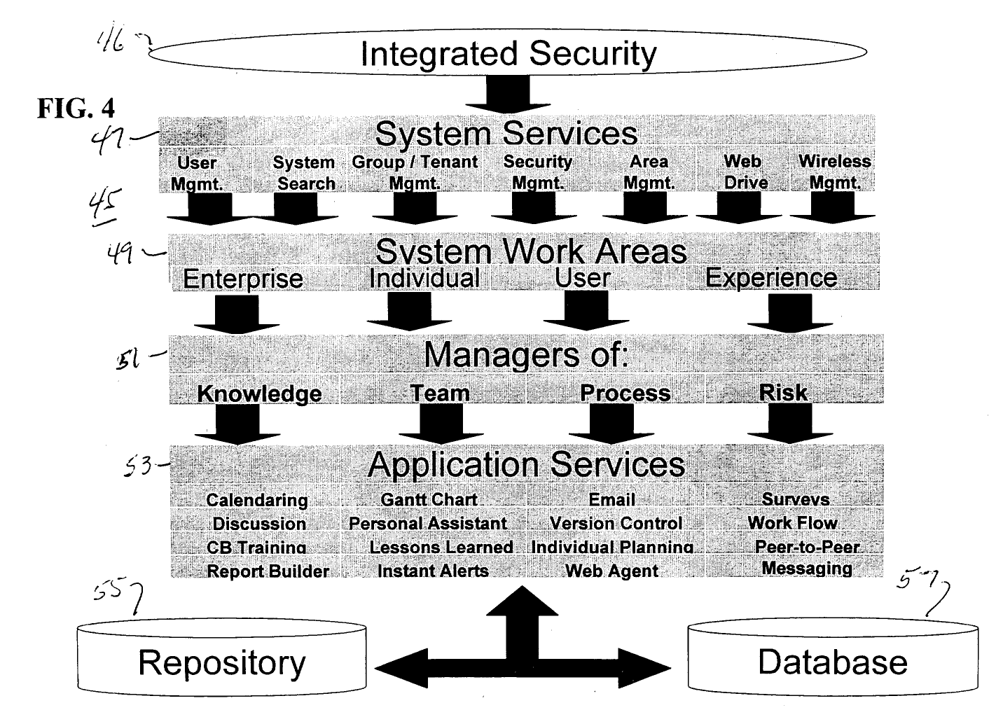

FIG. 4 illustrates a representative architecture, generally designated 45, for the Method and System, which includes Levels of Operations and which is an Automated Process. Through this architecture 45, users with proper authority, enter through Integrated Security 46 which has access to System Services 47 necessary and sufficient for performing work in Enterprise, Project, Experience or Personal areas. Project, for the purpose of this invention, is all that is known about an Individual Student who is the subject of the Individual Transition Plan. As can be seen in FIG. 4, System Services may encompass User Management, System Search, Group/Tenant Management, Security Management, Area Management, Web Drive and Wireless Management. For example, the user can choose to work on the Internet through a browser, or using the local user's operating system and a feature known as Web Drive as the window to all services necessary to manage Knowledge, Team, Process and/or Risk. This architecture automatically displays to the user those capabilities and features necessary to perform this management in a natural way through context sensitive windows matched to specific procedures embodied in the Method.

The System Work Areas 49 of FIG. 4 may include Enterprise, Individual, User and Experience Areas. A Manager's layer 51 may include Knowledge, Team, Process and Risk. Application Services 53 may include Calendaring, Gantt chart, Email, Surveys, Discussion, Personal Assistant, Version Control, Work Flow, CB Training, Lessons Learned, Individual Planning, Peer-to-Peer, Report Builder, Instant Alerts, Web Agent, Messaging and the like. Application Services 53 may bi-directionally communicate with memory or repository 55 and/or with a database 57.

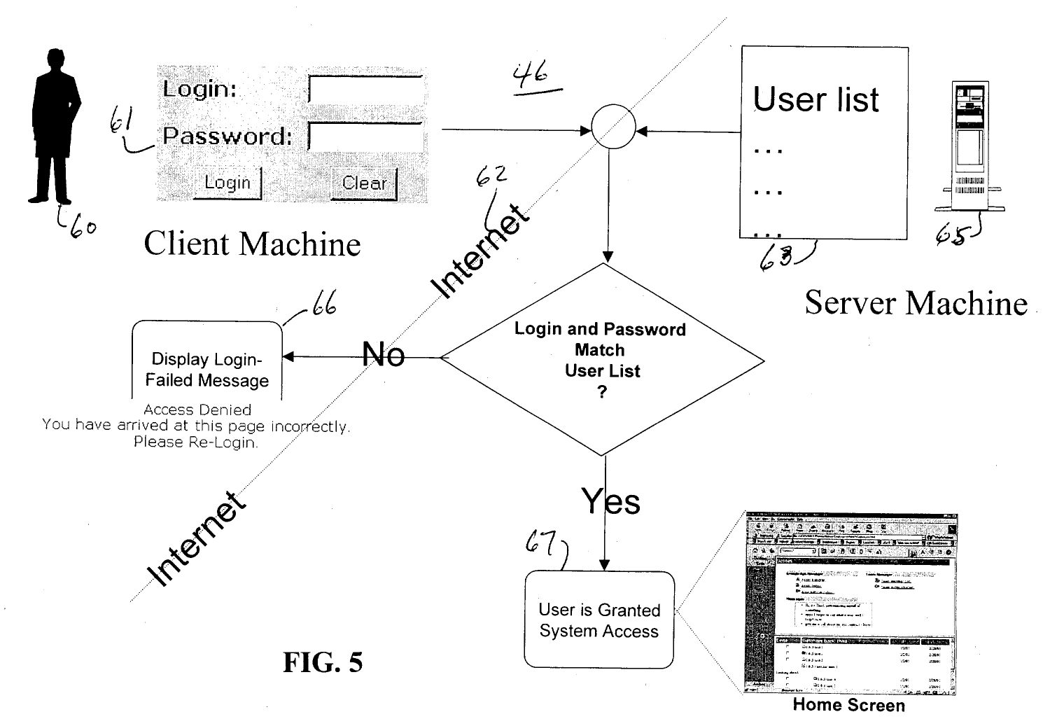

Initial entry to the system is provided through Integrated Security, generally designated 46, in FIG. 5. Here, a user 60 provides a login code 61 via the internet 62 that uniquely identifies the user, along with a claim of authority to login as that user. The system, such as a server machine 65, then compares that claim of authority, against a user list 63, with prior knowledge of that user. If the claim is invalid, such as indicated by message 66, the login fails. If the user has authority to login to the system, as indicated at block 67, then the system verifies user permissions and allows the user to select from authorized modes of entry into the system for that user using the media they have chosen to access the system through an existing ongoing session, or by creating a new session. The user is then granted entrance and use according to the permissions associated with that user in the particular mode of the session. Security permissions at all security levels together with current membership and account status relative to those security levels, determines entirely what the user is allowed to see and to know about the existence of Method and System resources, Assets, functions and features.

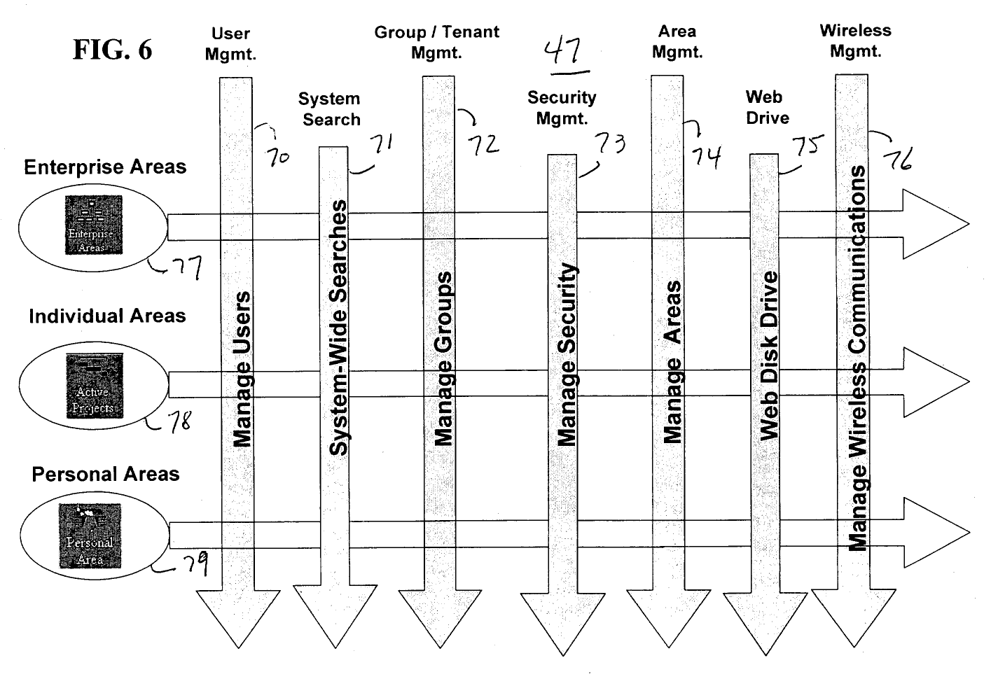

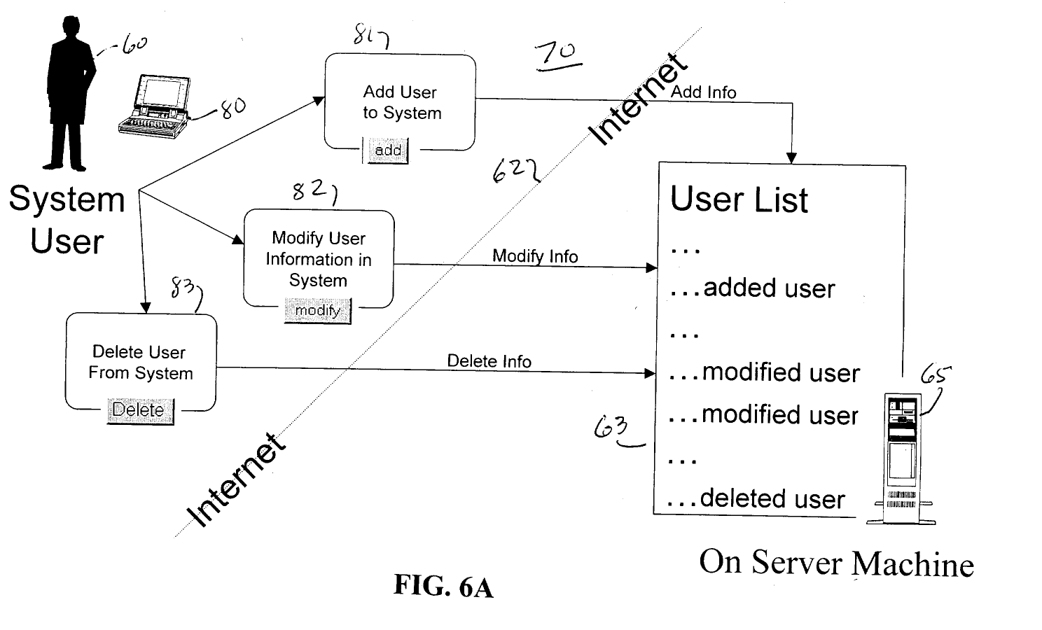

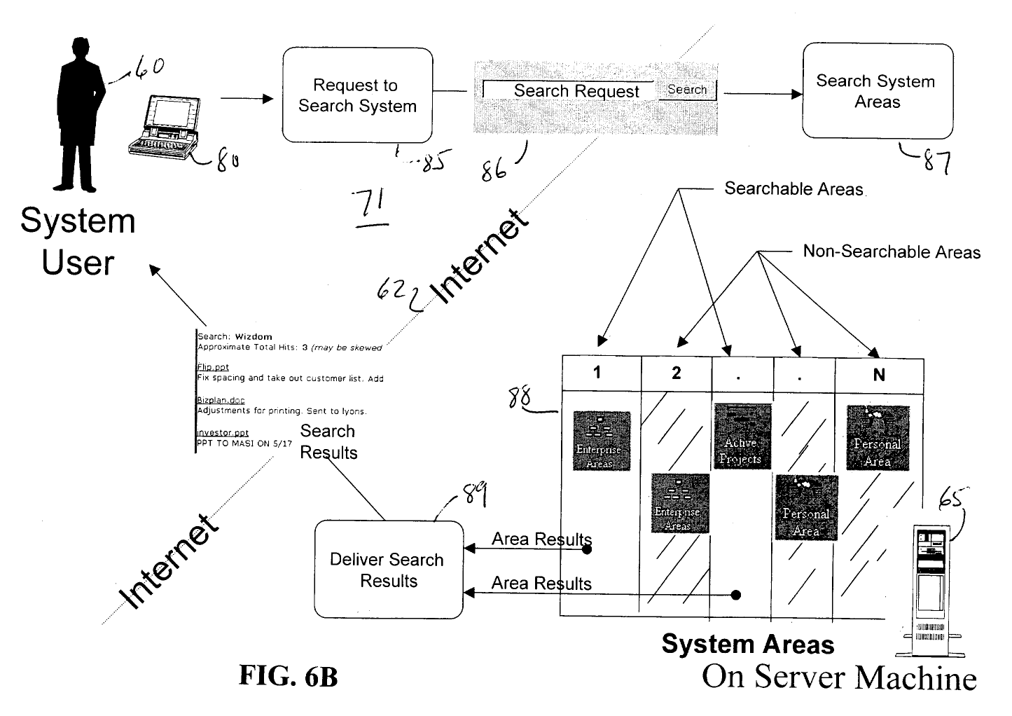

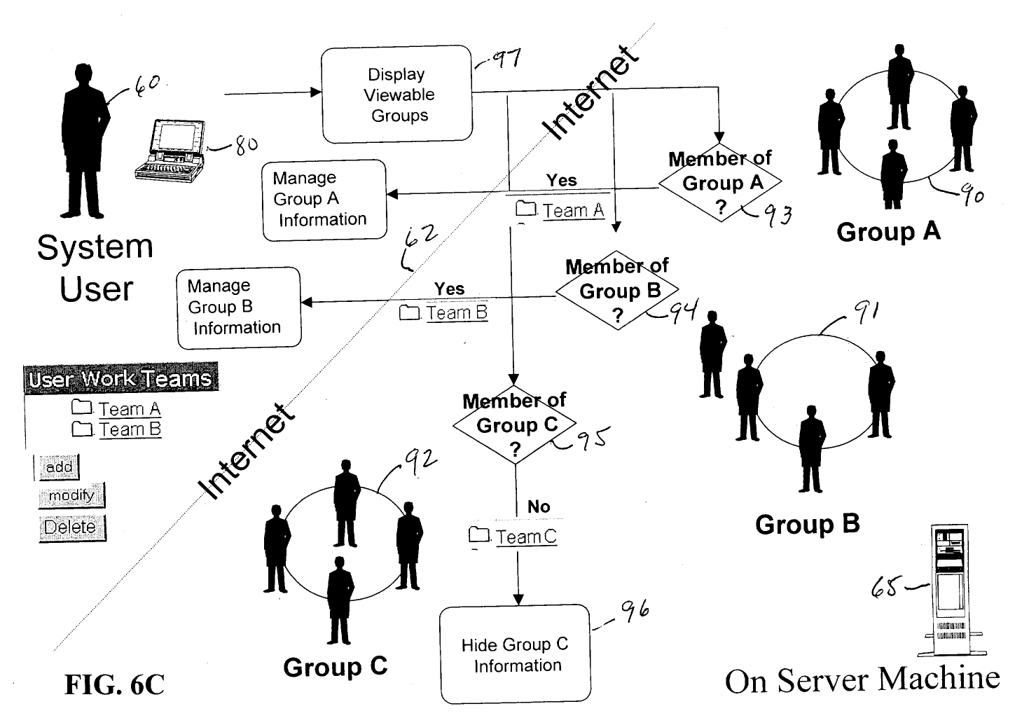

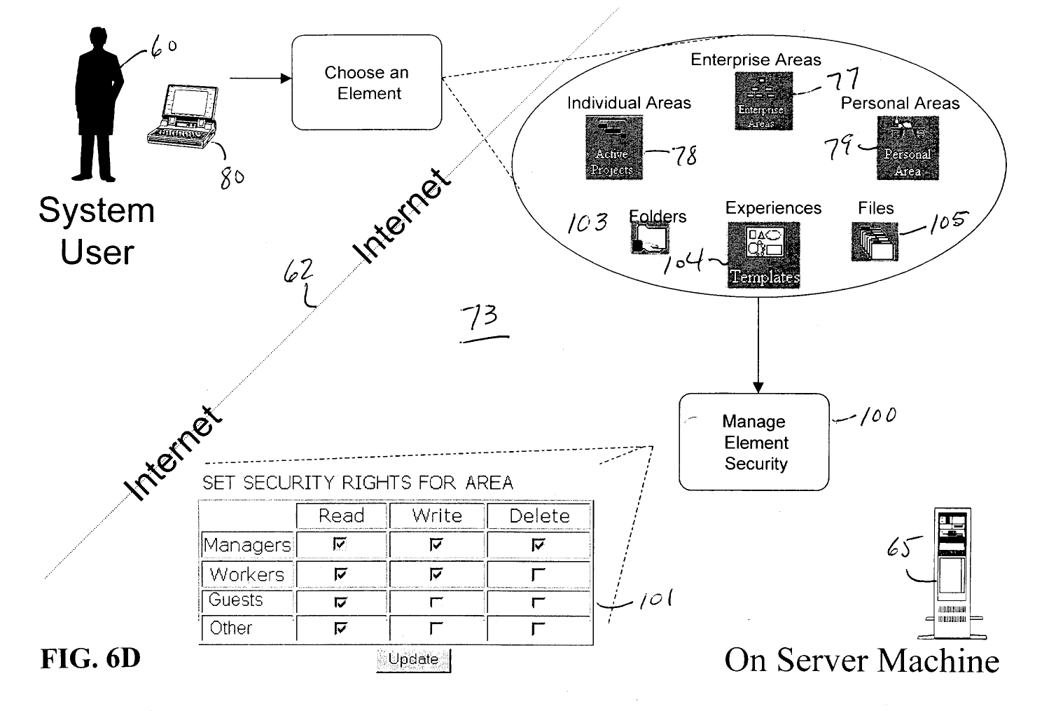

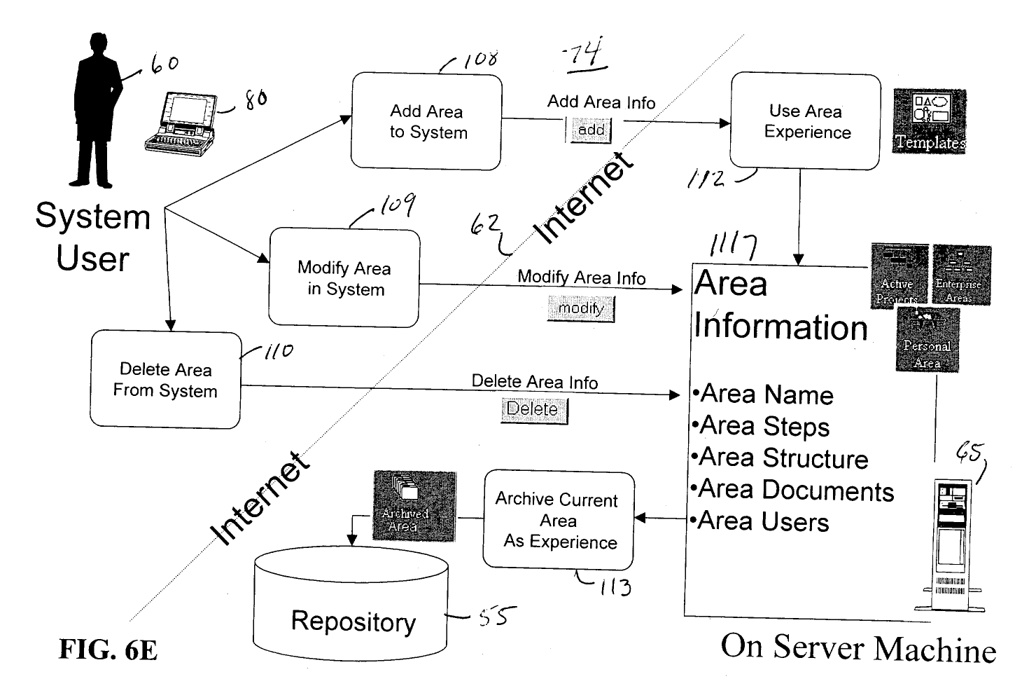

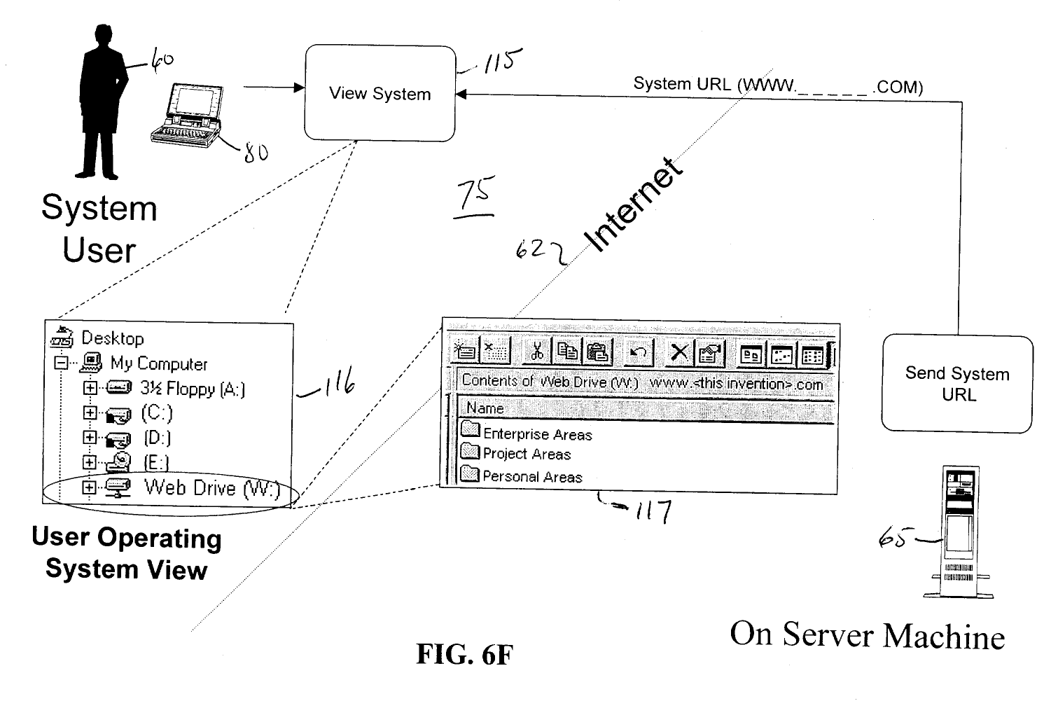

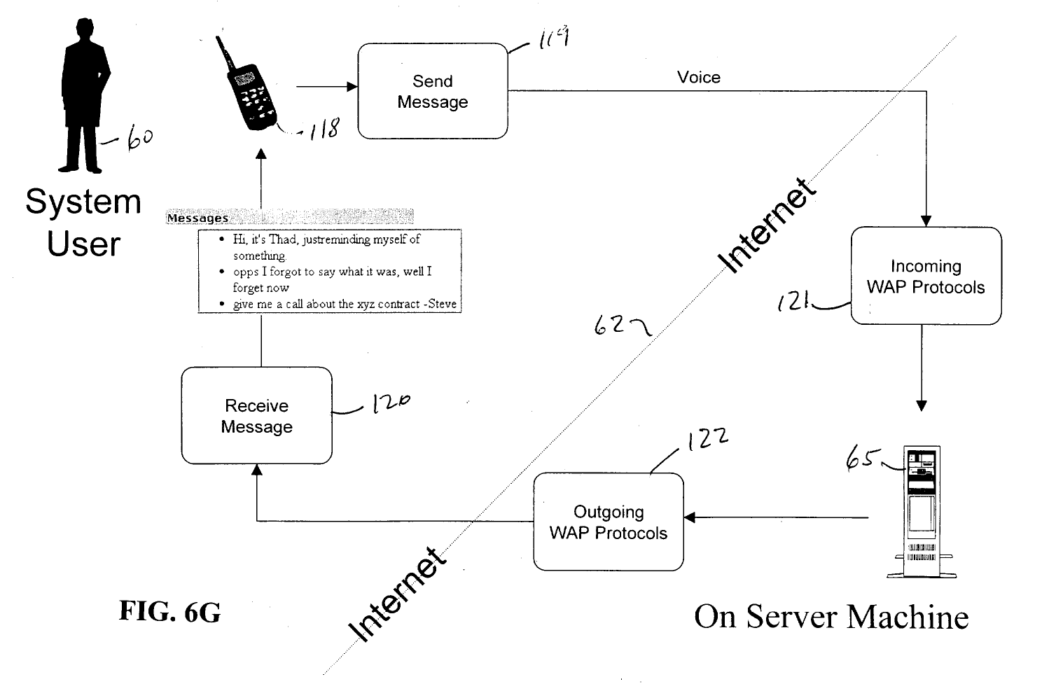

The first permission assigned is entry to System Services, generally designated 47 in FIG. 6, which provides access to system wide utilities, the use of which affects the perception of the system, by potentially all users, and provides access to information and Knowledge that may cross between Individuals which use is dependent upon the manual or automatic state of the Method and System. In the example of FIG. 6, the System Services 47 include User Management 70, System Search 71, Group/Tenant Management 72, Security Management 73, Area Management 74, Web Drive 75 and Wireless Management 76, any of which may interact with one of the selected System Work Areas 49, which include Enterprise Areas 77, Individual Areas 78 and Personal Areas 79.

Each of the several System Services 47 will now be presented in further detail in FIGS. 6A-6G. Through User Management, generally designated 70 in FIG. 6A, the User 60 via a laptop computer 80 with access to the Internet 62 and with proper permissions selects other users from an existing list of preauthorized potential users to work on or in Shared Areas. Depending on his/her specific permissions the user may add a user as in block 81, delete a user as in block 82, or modify user information as in block 83 in the User List 63. This specific user information is then added to the list of user information for the particular user. When a new User is added to an area, an Alert goes to that person and the Team providing necessary information to the User and to the Team. User information is resident on the Method and System server from where it is accessible through any network client machine.

System Search service, generally designated 71 in FIG. 6B, enables the user to request a system search 85 and to enter a query 86, which then initiates a search 87, such as of System Areas 49, including subsets of the System Areas including Areas 77-79 in FIG. 6, which the user is allowed to search depending upon the users particular permissions as indicated in the search permission matrix 88. Search results 89 are returned in the form of references to Knowledge Assets (frequently documents) in the Knowledge Management Repository 55, or alternatively a message that a document exists but the user's particular permissions do not all access, or alternatively URLs to web sites and documents residing on the WWW.

The Group-Tenant Management service, generally designated 72 in FIG. 6C, allows Users to be placed in Groups 90-92. In this example, user 60 may seek via a laptop computer 80, or other communication device, to display information about viewable groups as in block 97. Particular Groups have particular permissions, such as indicated at decision blocks 93-95. Users in particular Groups have particular permissions. Particular Groups may have restricted ability to perceive other Particular Groups, such as at block 96, and Users and areas used by other particular Groups.

With reference to FIG. 6D, Security Management services, generally designated 73, defines four security levels: System, Group, Area, and Folder, such as to Areas 77-79, Folders 103, Experiences 104 and Files 105. Through Security Management services, properly permissioned Users can modify individual permissions, as at block 100, relative to particular sets of users and particular items in a Level (e.g. at the Area level security can be set on an Area by Area basis), as in table 101, to provide read, write, delete and other permissions or denial of permissions.

Enterprise, Personal and Project Areas are created, modified, deleted, archived or converted to Experiences 104 through Area Management services, generally designated 74 in FIG. 6E. Users who create an Area 111 have initially all security permissions in that Area as noted—Add Area 108, Modify Area 109, Delete Area 110, change Area Information such as Area Name, Area Steps, Area Structure, Area Documents, and Area Users except for that user information for which a permission at a higher level is required to change. All Method and System User activity then takes place based on Area-level security where explicit permissions are given individual users as discussed previously depending upon these permissions which can extend to lower security levels, such as Folders. The new Area 111 may be archived, as at block 113, with other Areas on repository 55.

Web Drive, generally designated 75 in FIG. 6F, provides automated access to the Method and System via translation of operating system level requests. Web Drive service allows users access to the Method and System through their Windows Explorer Application. This service allows access to the system repository without the need for the user to be in a browser environment. Used in this way the Method and System is integrated within Windows Explorer through the Common Object Model architecture (COM). Once the Windows Explorer is launched, users can see, via block 115, the Web Drive listed at the highest system directory level 116, along with the standard, C:/, A:/, and other local and network drives mapped to the User's client. Selecting the system drive will then expand to the next level 117, similar to use in the browser environment for Project, Enterprise, Personal, and Shared work areas. From Windows-Explorer, users have the same access to the same Methods they would have from the browser. Users can drop and drag files from the system server drive to local drives and vice versa. Users can also utilize the local utilities within Windows Explorer, such as search, copy, edit and delete. They can also check-in and check out files to the system server directly from Windows Explorer.

Wireless Management, generally designated 76 in FIG. 6G, allows the Method to be used with Wireless Application Protocol (WAP) devices to at least send and receive messages 118 and 119, respectively, with incoming and outgoing WAP protocols 121 and 122, respectively. The specific capabilities of the Method will depend upon the features and capabilities of the selected WAP device 118.

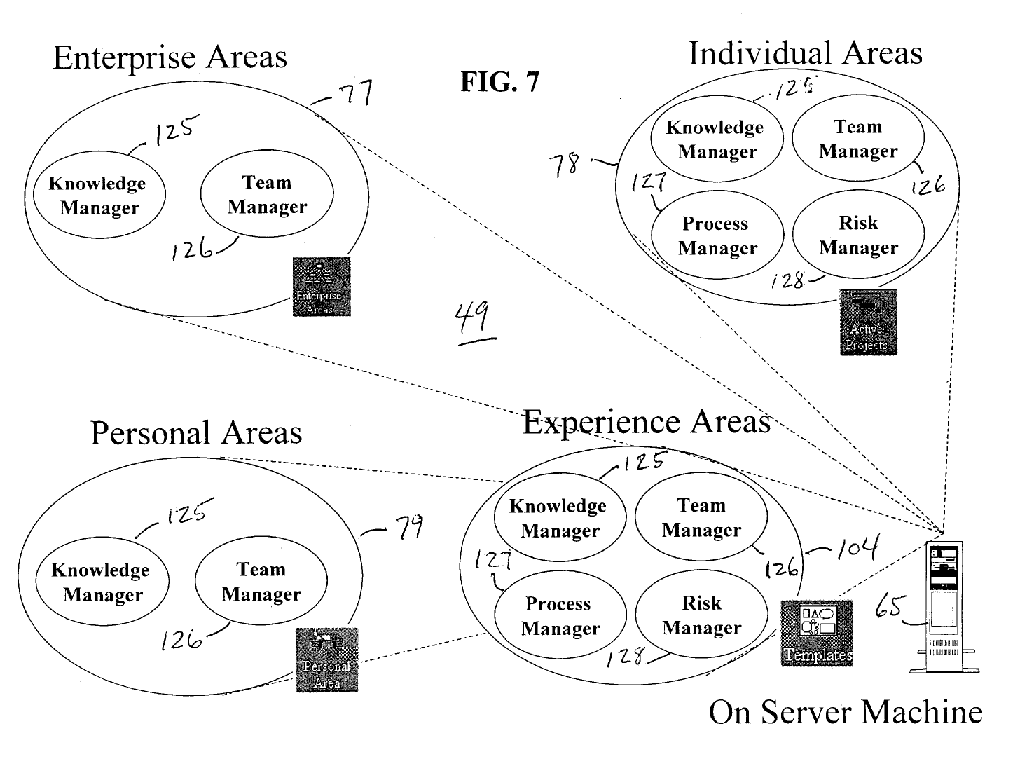

System Work Areas, generally designated 49 in FIG. 7, provide access to Enterprise 77, Individual 78, Personal 79 and Experience Areas 104. Enterprise Areas 77 represent ongoing components of the Enterprise complete with Knowledge Manager 125 and Team Manager 126. Enterprise Areas 77 are those within which Teams exchange information and knowledge across the Enterprise such as Personnel and Facilities which must be done consistently and by obeying certain standards and procedures. Individual (or Project Areas) 78 areas represent a Project(s) that takes place over time according to a plan (Process) and have their own Knowledge Manager 127 and Team Manager 128 along with specialized software for creating and optimizing plans (Risk Management). Individual Transition Plans as they evolve over time and as part of the Individualized Education Program are Projects. Thus, Project, is all that is known about an Individual Student who is the subject of the Individual Transition Plan. Personal (or User) Areas 79 represent a virtual office for the User with Knowledge Manager 131 and Team Manager 132 and the ability to allow other Users to access that Repository in the form of Shared Areas. Experience Areas contain a Knowledge Manager 133 with Assets that are necessary or useful in learning from having accomplished certain Transition Plans. Experience Areas 104 may also contain a profile for Risk Management. Analyzing Experience reveals patterns that should be either avoided or repeated.

Knowledge, Team, Process and Risk managers 125-128 in FIG. 7, respectively, allow user's access to specific Application Services 53 in FIG. 5. Knowledge Manager 125 allows a user 60 to access and modify knowledge, at block 140, in a repository 55 which may be connected to a file system, database 57, server 65 and/or other data sources, for example, the World Wide Web via the internet 62. Team Manager 126 allows users to view and to modify the relationship, at block 141, of users of the system to the given Area and to modify the security settings of a given User relative to that area. Process Manager allows Users to view and modify a plan and to manage all aspects of that plan. Risk Managers provide users, at block 143, with access to an advanced survey and analysis tool that surveys a Team and based on that survey results in an analysis of the risks involved in a plan. Based on those risks, the Risk Manager chooses Tasks specific to the requirements of the Individual and automatically generates a plan and schedule to accomplish those requirements.

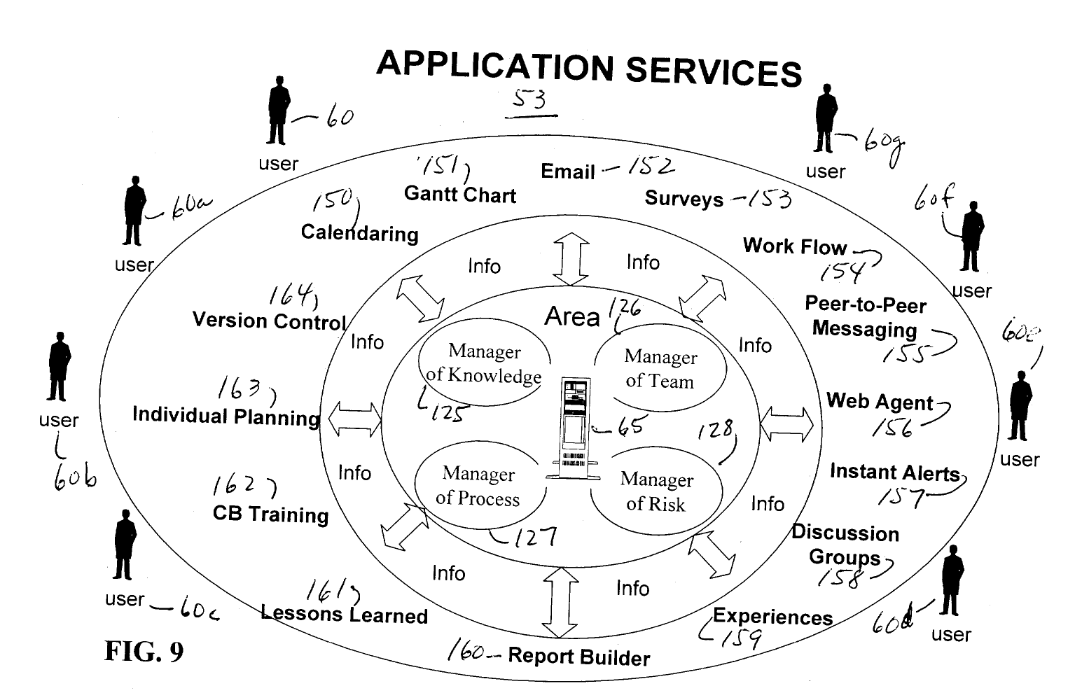

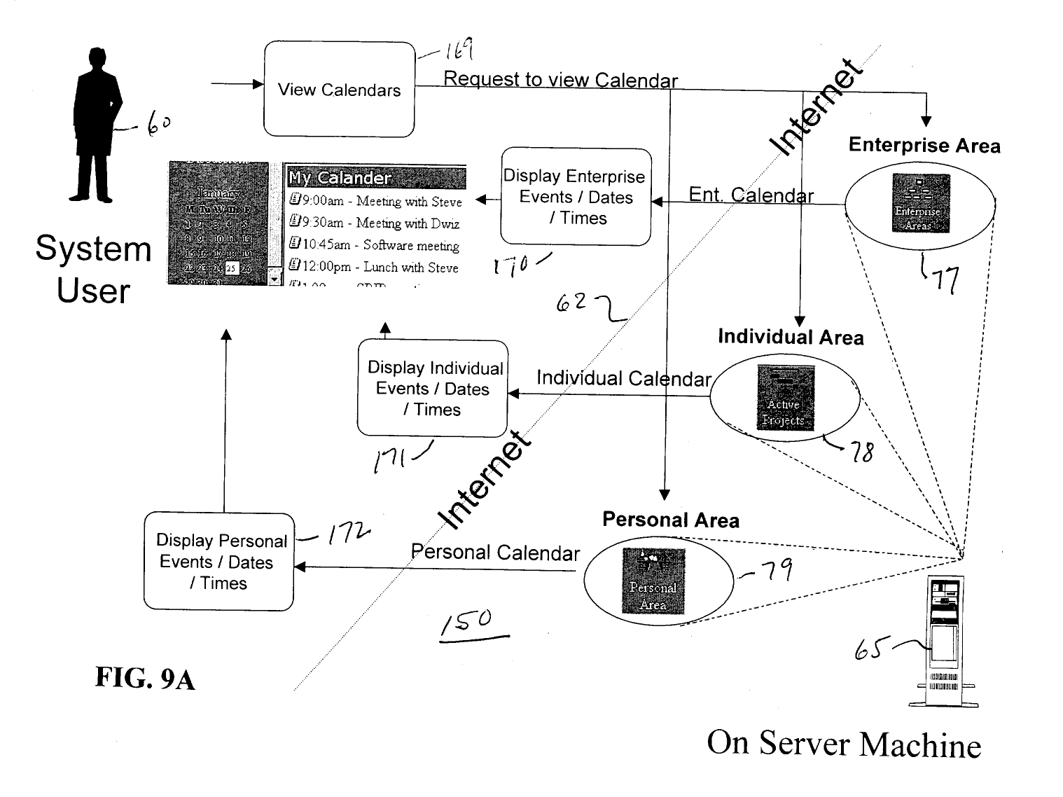

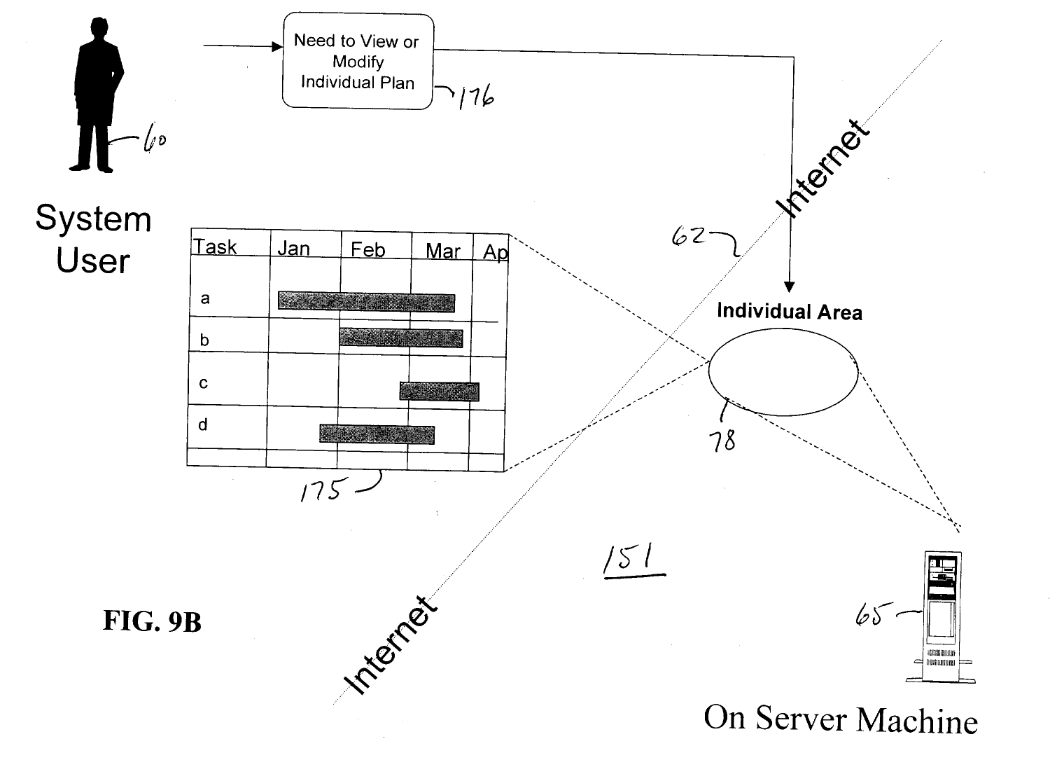

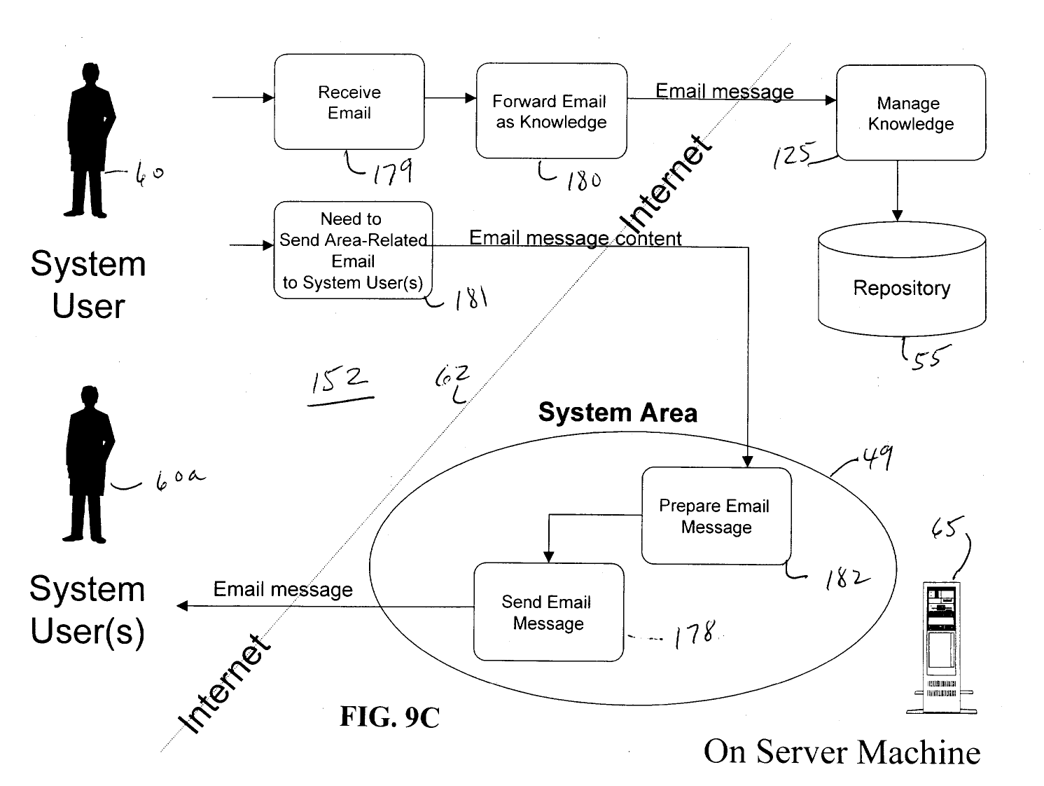

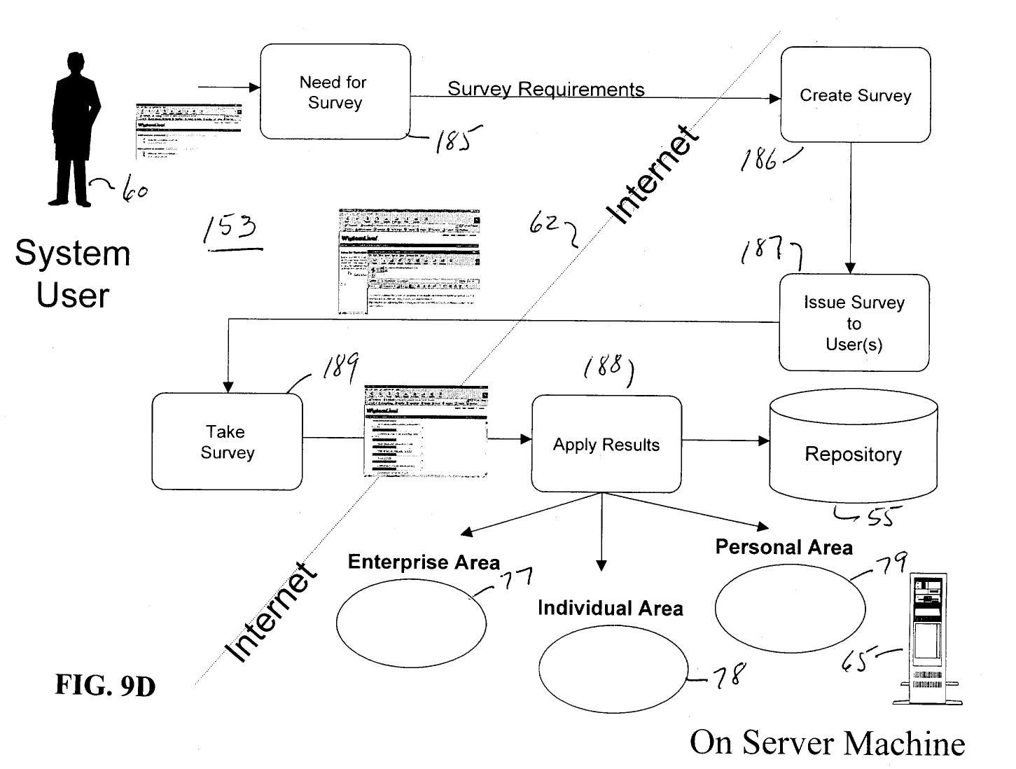

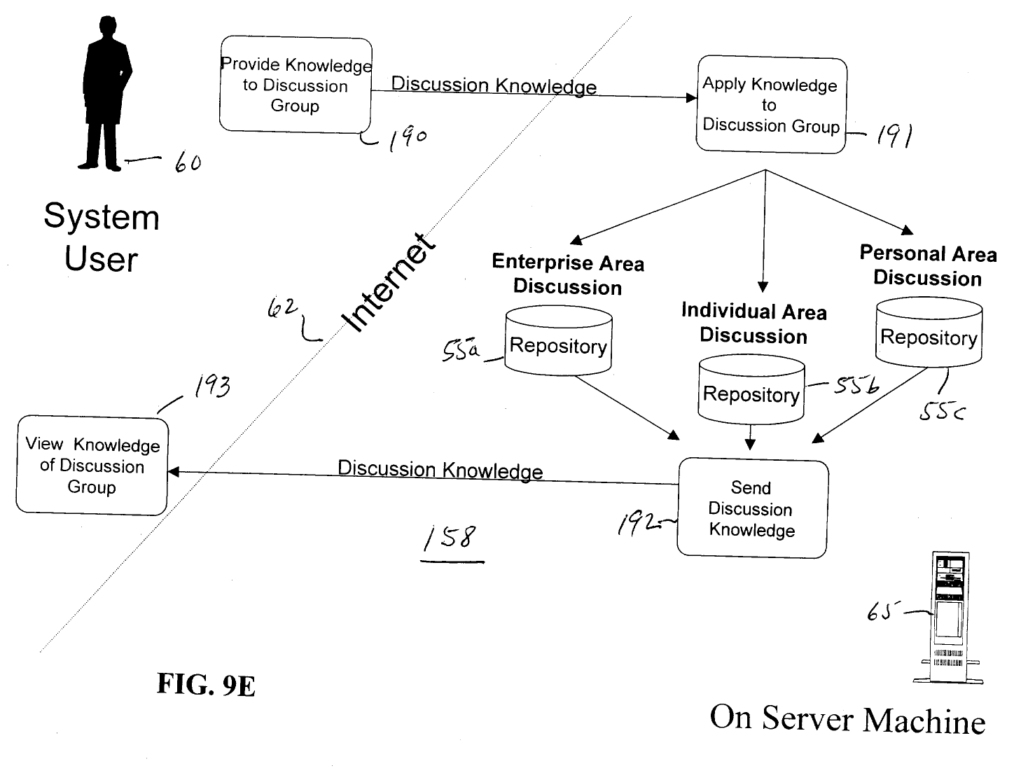

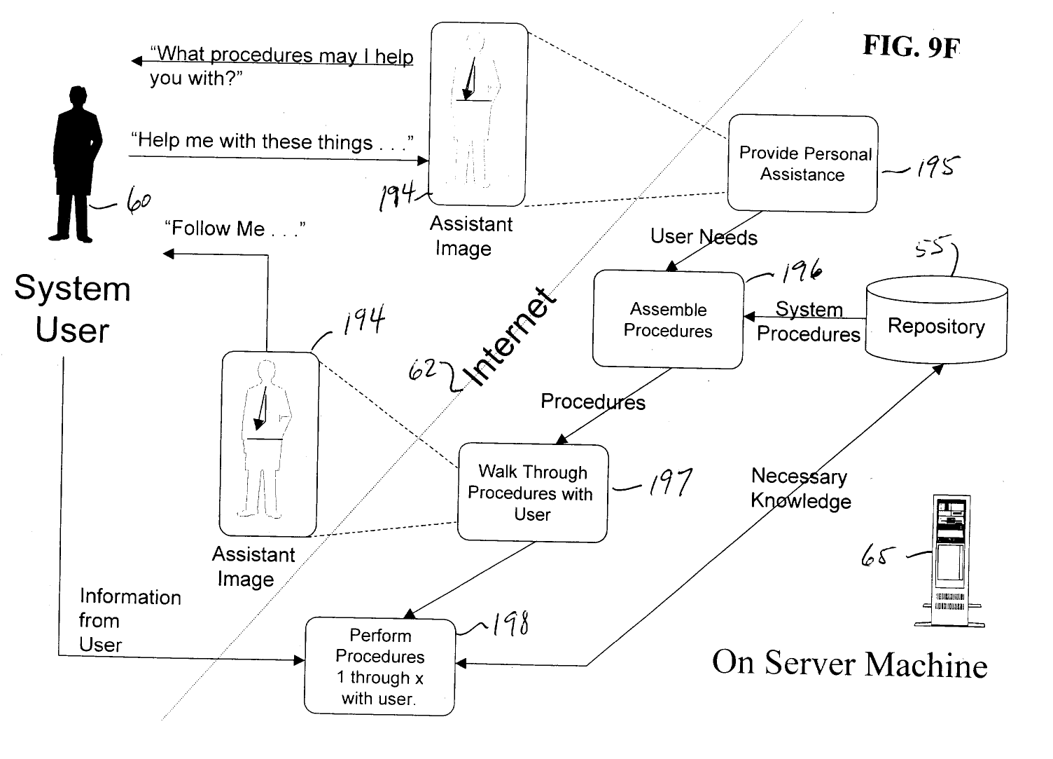

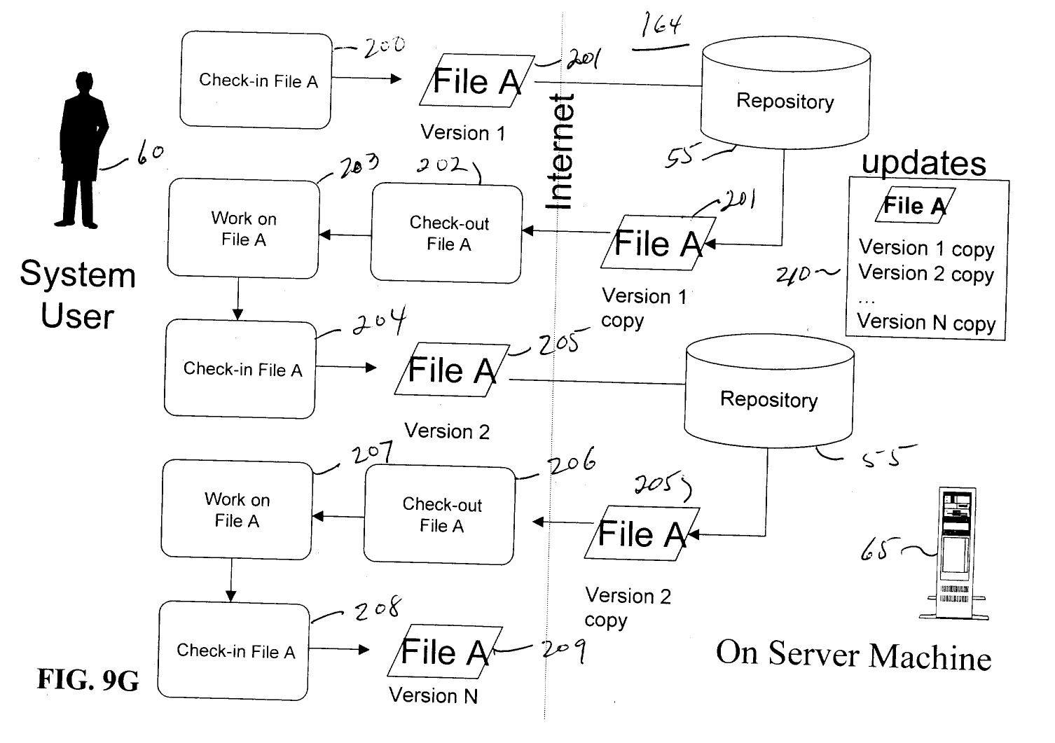

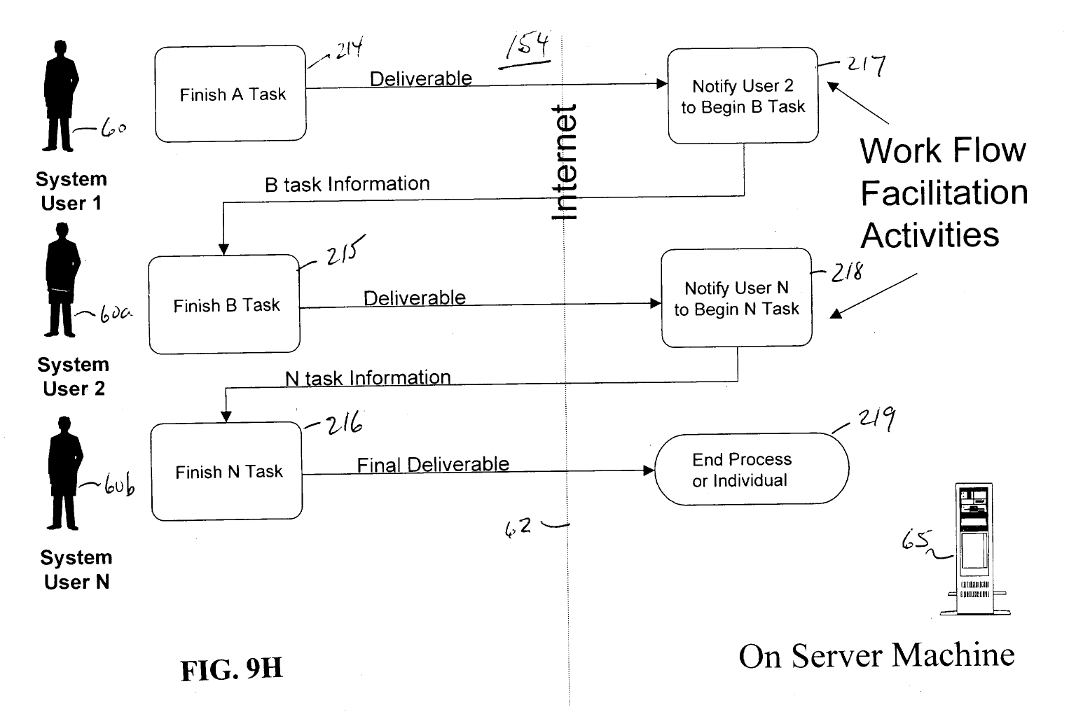

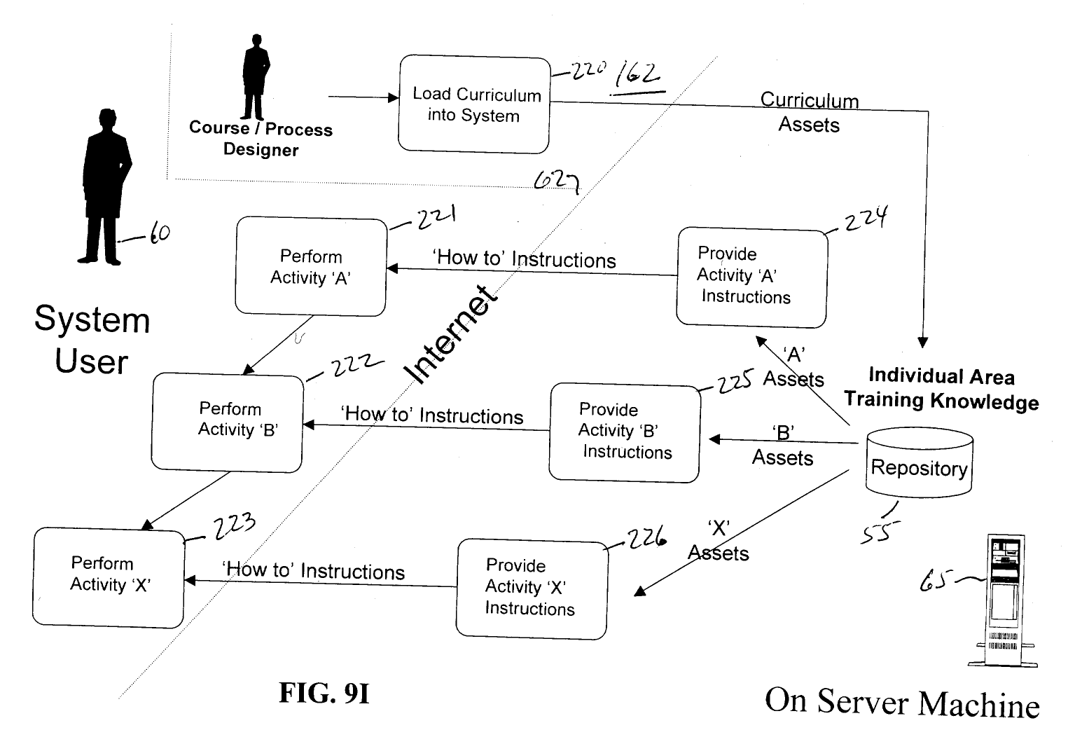

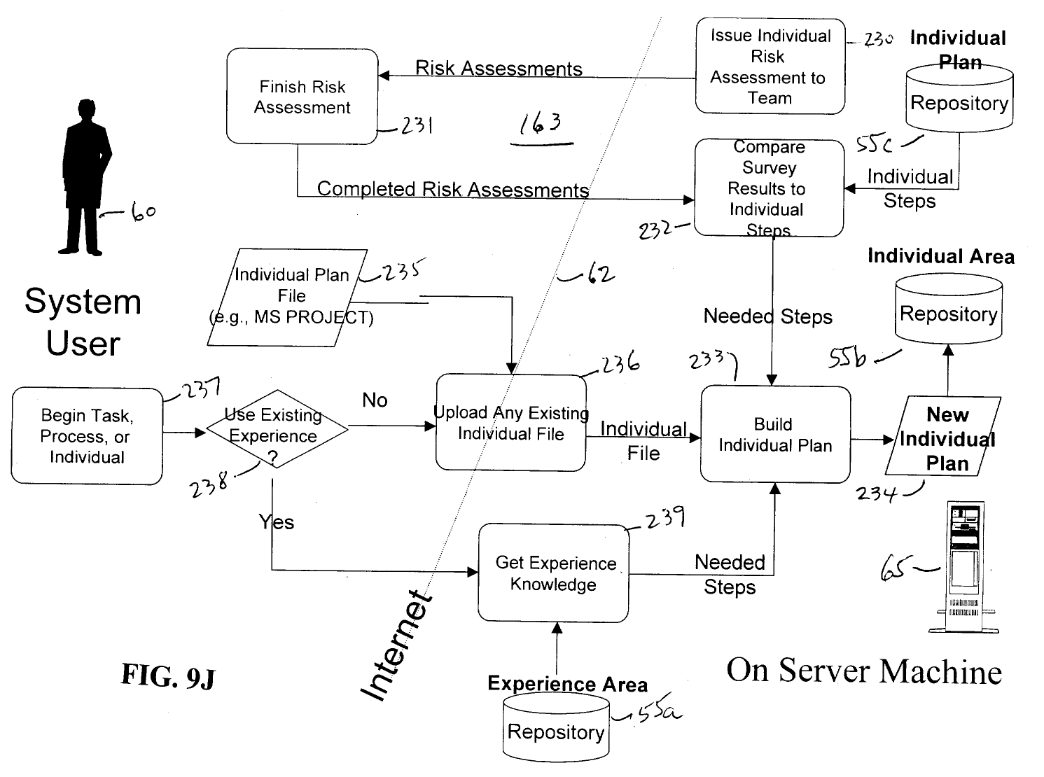

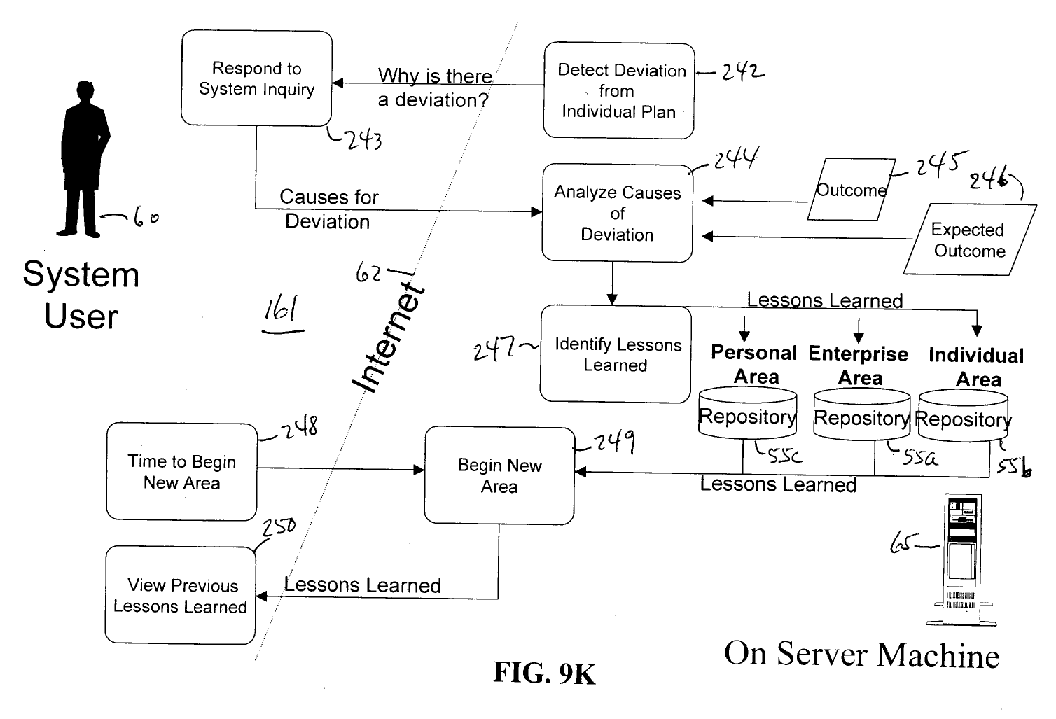

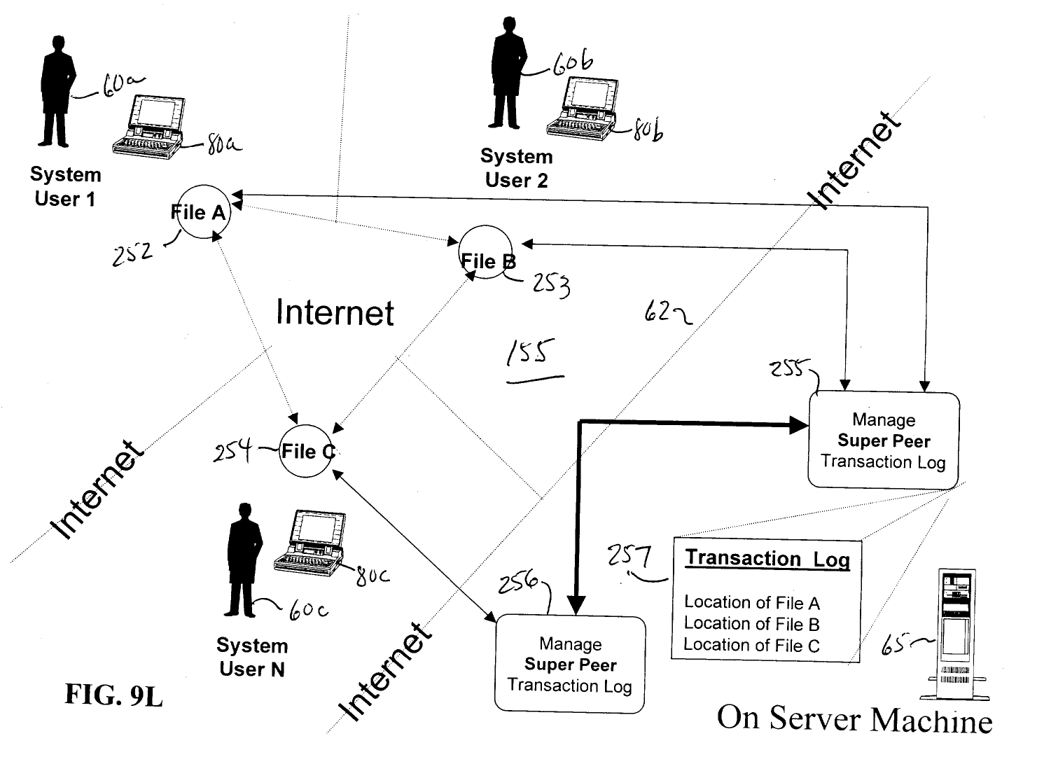

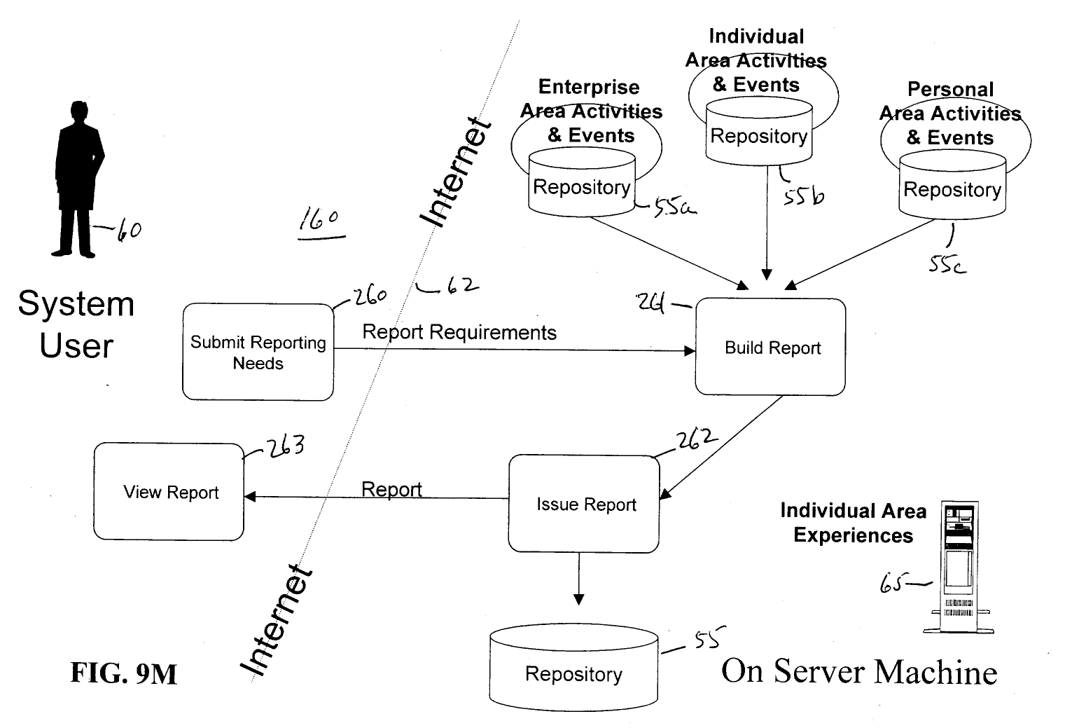

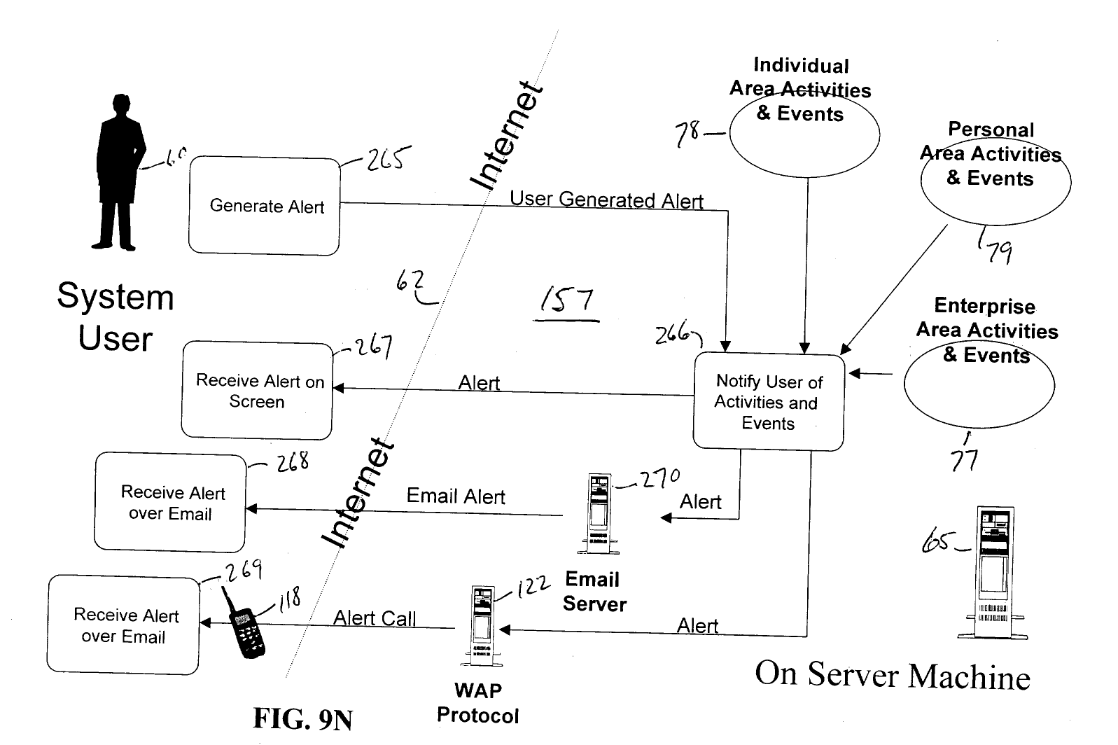

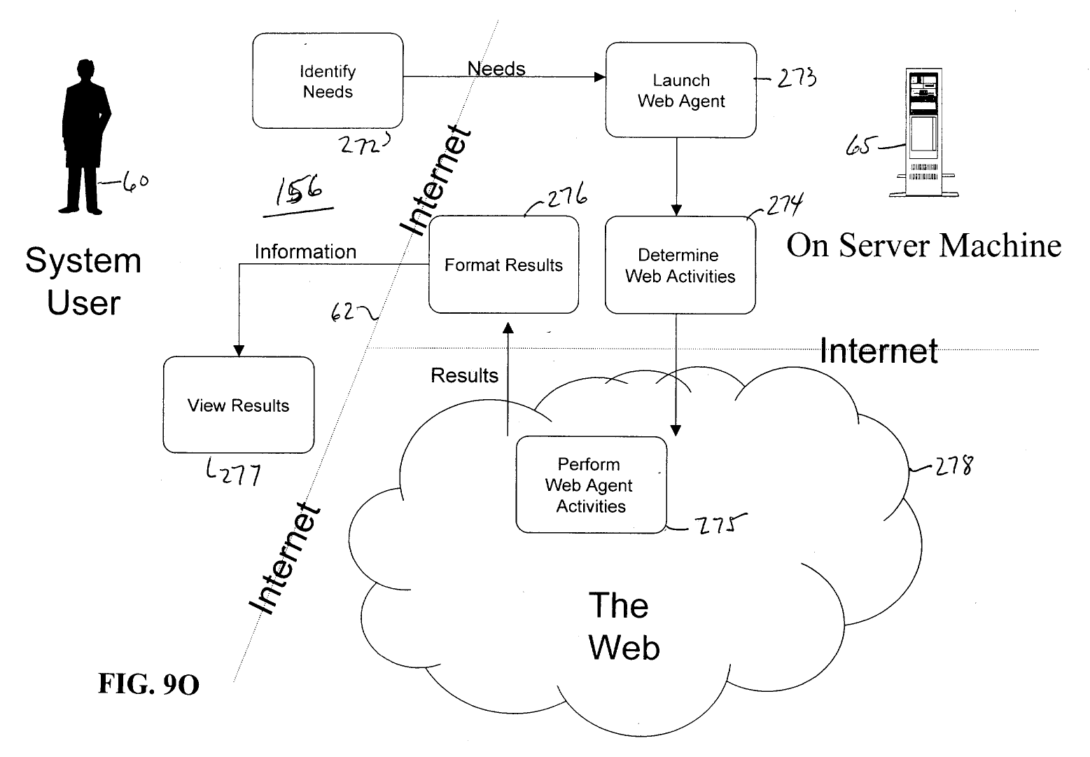

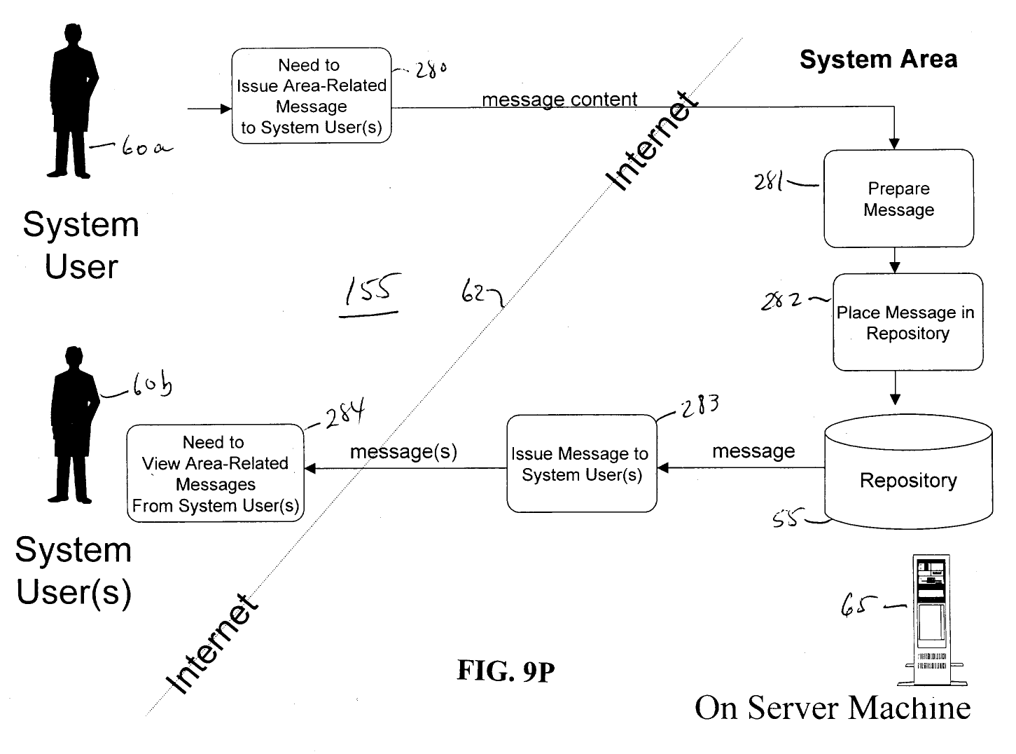

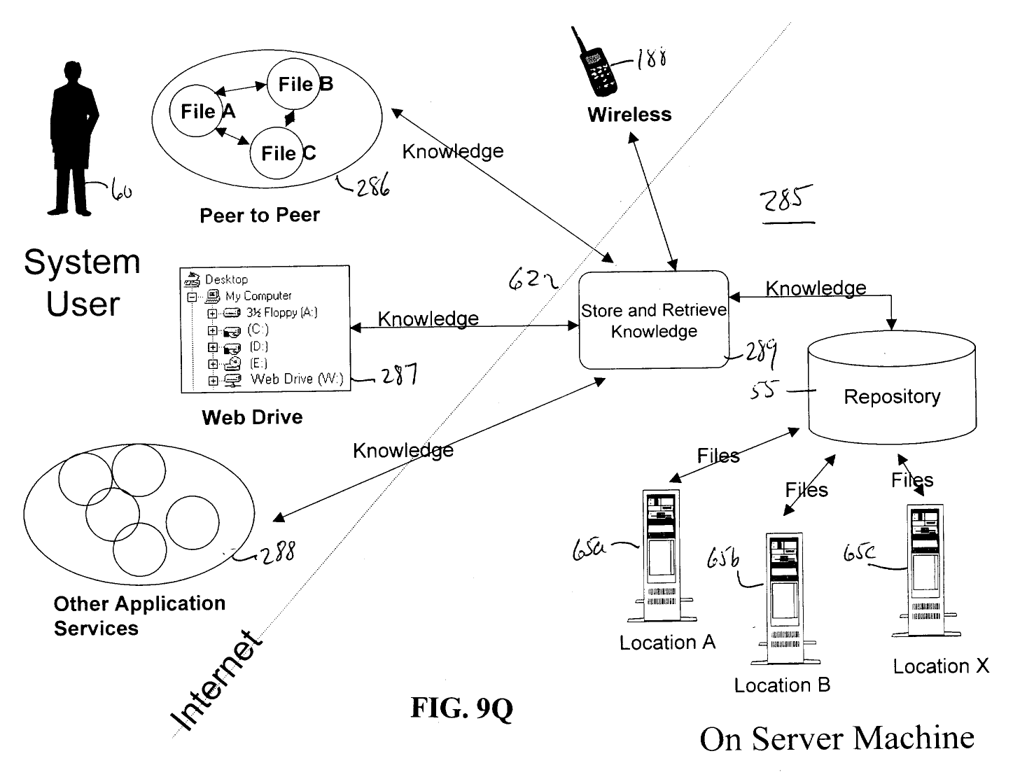

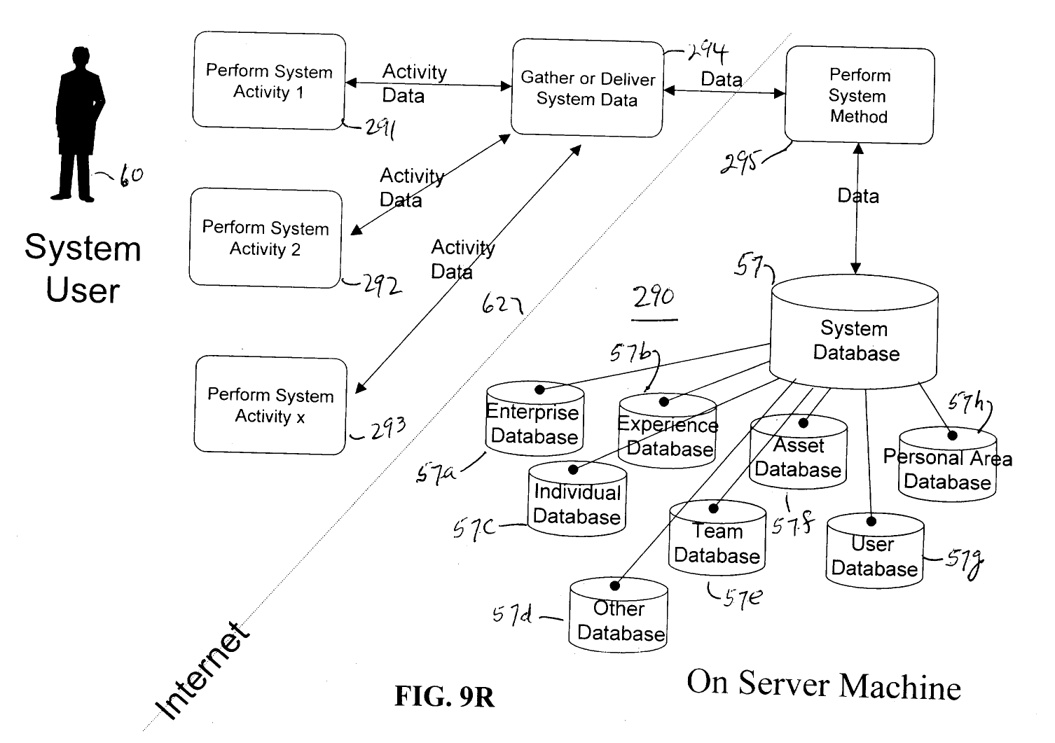

Application Services, generally designated 53 in FIG. 9, provide System and User access, such as to a plurality of users 60-60g, to specific applications, such as applications 150-164, which may be invoked to accomplish a particular purpose of the Method. These fifteen applications 150-164 are representative and not inclusive of the Method and System capabilities.

In Calendar Application, generally designated 150 in FIG. 9A, Calendar items are associated with Personal Areas 79, Individual Areas 78 or Enterprise Areas 77. Users 60 and events that are relevant to a calendar item, represented as a span of time, are associated with that calendar item. A list of Calendar items is maintained that represents an ongoing calendar. Calendar items may be viewed, at block 169 as events with date and time listed by any of the three areas, such as at blocks 170-172. Individual items may be filtered by Teams, Groups, Projects, Areas, Users according to permissions and preferences.

Gantt Charts, such as chart 175 in FIG. 9B, are a particular type of graphical representation showing events by start time and duration. The Gantt Chart Application, generally designated 151, of the Method and System provides this representation based upon this information being entered into a Project Area directly, or by being downloaded to the System from third party software, for example, Microsoft Project™, automatically. In addition, the Gantt Chart Application 151 can associate Project resources with each event and can download this same resource information from Microsoft Project. This same information can be uploaded to Microsoft Project. Thus, the Gantt Chart can be viewed, at block 176, alternatively from the System on the User Client machine within the Method, or it can be viewed using Microsoft Project.

The Method and System provides for an Email Application, generally designated 152 in FIG. 9C, that is in context with and within Areas 49. Thus, information sent, block 178, and received, block 179, via email is maintained as knowledge Assets in the repository 55. Email is either automatic in the form of Alerts that an event has occurred, such as a change in the Knowledge Base relative to a particular process in a particular Project, or may be specific between Teams, or Team members, for example, a new User has been added to a Team.

Needs, Skills, Preferences and Levels of Performance are an integral part of the Transition Process. The Method and System includes a Survey Application, generally designated 153 in FIG. 9D, to provide for automatic issuance of surveys, block 187, to Team members to determine issues including, but not limited to, a lack of understanding of the Individuals preferences, or the Team in place does not have the proper skills to complete the Transition Process. Identifying these and other issues is accomplished through an on-line survey. The survey results are then applied to the various Areas 77-79.

The User, with Manager Permissions, sending them over the Internet to the Team members by e-mail, accomplishes completing the survey in an IEP physical or virtual meeting. Based on the results of the survey, the Method identifies the Individuals Performance Objectives and current level of Performance.

Identifying Needs, Skills, Preferences and Levels of Performance are key to the Transition Process. A Discussion Groups Application, generally designated 158 in FIG. 9E, can be formed among Teams or Users in Enterprise Areas, Project Areas, and Personal Areas. Providing discussions, block 190, to a group, block 191, allow Team members to conduct ongoing dialogue with each other relevant to activity in general or specific to an Individual. Discussions are considered to be Knowledge Assets. These Assets are stored in the Repository 55, such as Repository portions 55a-55c. These Assets may be viewed, block 193, passed on, block 192, and applied within or between or among Discussion Groups.

A Personal Assistant Application illustrated in FIG. 9F provides two interrogation functions: “Help me with these things” and “What procedures may I help you with?” Based upon certain Method and System Procedures contained in the Repository 55, Personal Assistant 194, for particular purposes: 1) Assembles Procedures in block 196, 2) Walks Through the Procedures with the User in block 197 (including a “Follow me . . . ” command) and 3) Performs Procedures with the User in block 198. Personal Assistant 194 may be invoked by the User 60, or may be invoked automatically by the System. An audit trail of the use and effectiveness of Personal Assistant is maintained, which is interrogated by a Personal Assistant agent searching for improvement in Personal Assistant effectiveness.

A Version Control Application, generally designated 164 in FIG. 9G, maintains every Version 202, 205 and 209 of every document (knowledge asset) checked into the Repository 55. Every Version is accessible for viewing or downloading by any user with appropriate permissions. Each Version is associated with the User 60 who created that Version along with date/time of Check-in, blocks 200, 204 and 208, and a description of the changes from the previous version. Users with appropriate permissions may establish which other user types have access to a particular Version. Users with appropriate permissions may Check-out, blocks 202 and 206, documents for use. While documents are checked out, other Users with appropriate permissions may view these documents, but each is on notice that no other User, than the User with the checked out document, has the permission to Check-in a document with the same name as a new version. All document Versions together make up the “Document History” and may be placed on the clipboard 210 to be later pasted into another Folder.

A Workflow Management Application, generally designated 154 in FIG. 9H, is accomplished when upon completion of a Task at blocks 214-216; users of following Tasks are notified at blocks 217 and 218 so that they may use Assets that were developed during prior Tasks. Knowledge Assets created during prior Tasks are available to users upon notification. The String (Flow) of Knowledge Assets is constantly available to Users with appropriate permissions to view what work has been previously accomplished.

A Computer Based Training (CBT) Application, generally designated 162 in FIG. 9I, is facilitated in two fundamental ways: 1) Each Transition Process Activity at blocks 221-223 has associated instructions at blocks 224-226 for how to perform the Task. 2) A Transition Process could itself be a training course(s). In the former instance, each Task has associated “how to” instructions. These instructions themselves are the contents of CBT particular to the Process. That is, the process logically informs the student exactly how each process is to be performed at the precise time that it must be performed. In the second instance, a CBT curriculum could be loaded into the System and become the specific focus of the Method. In other words, the CBT curriculum becomes the method and is delivered through the System considering the content of the curriculum as Knowledge Assets and the order of the Assets to be presented as the Process.

An Individual Plan Application, generally designated 163 in FIG. 9J, creates Process Plans at block 234 either through the Risk Manager at blocks 230 and 231 or following Survey completion at block 232, in which instance the Process Plans are automatically generated. Alternatively, previously generated and executed Plans at block 235 may exist which are uploaded at block 236 to the System that now become part of the Method for a particular purpose. In each instance Plans are created only with appropriate permissions. Associated with each Plan may be exactly how each Process in the Plan is to be conducted, Gantt Chart information, Repository locations 55a-55c for Knowledge which will be associated with each Process step, Team Members, Expected outcomes, and other non structured information deemed necessary by the User with appropriate permissions.

A Lessons Learned Application, generally designated 161 in FIG. 9K, provides the opportunity to view previous Lessons Learned at block 250. During the conduct of the Plan, there may occasion, a perceived need to deviate from the plan. The Method considers this need to be opportunity for Lessons Learned. When a User with appropriate permissions, wants to change the Plan, the System requests an explanation at block 247 from the User which is stored in the Individuals Area from which that Plan was created so that other Plans with the same or similar processes may benefit from knowledge gained while undertaking that Plan. Accordingly, when the System detects Deviation in Activity at block 242, it asks the Deviator for the Reasons for the Deviation at block 243 and analyzes Reasons for Deviation at block 244. Then, upon completion of the Plan, the System looks at the outcome of the Plan at block 245 compared to expected outcome at block 246, identifies Lessons Learned at block 247—“Was the outcome better or worse than the plan expected?”—and then applies the Lessons Learned to creation of the next Plan. Lessons Learned can be applied to Enterprise Areas, Individual Areas, or Personal Areas. All Lessons Learned are maintained in the Repository 55a-55c.

In a Peer-to-Peer Application, generally designated 155 in FIG. 9L, Users 60a-60c may choose to maintain Assets on their local computer 80a-80c and share them with other Team members via a peer-to-peer connection monitored by the System to maintain a log of those transactions at block 257 rather than through the System Server 65, which may also be defined as a Super Peer. Users make general network requests through their peer connections to the Super Peer which implements an expanded instruction set. The Super Peer acts as a proxy for the originating peer until the time for actual bulk data transmission arrives, then based on the ability of the original peer to accept/make a network connection from/to another data source the Super Peer steps aside to let the data transmit directly or acts as a conduit for the data to pass through. Alternative configurations allow for multiple peers connected to a given Super Peer, and multiple Super Peers. Peers and Super Peers interact using the same instructions set. Super Peers implement an expanded from of the basic instruction set and can communicate with each other and appear as peers to all other peers and Super Peers on the network. All connections are made through Super Peers, which by definition support the instructions necessary to facilitate a connection.

In a Report Builder Application, generally designated 160 in FIG. 9M, User defined reports display information at block 263 about the status of Individual Students (Projects) and Assets maintained in Areas. Report Requirements and layout may be identified by the User for the Enterprise, Project and Personal Area Activities & Events. The User Submits Reporting Needs at block 260 and can then View Standard Reports at block 263, Build Reports at block 261, and Issue Reports at block 262. Experiences contain standard reports.

Under an Instant Alerts Application, generally designated 157 in FIG. 9N, Alerts are triggered at block 266 by important events sensed automatically by the System in Project, Personal or Enterprise Areas and directed to particular Users at blocks 267-269 through all mediums including email at block 268, on-screen displays at block 267, and by WAP devices 118 at block 269 at the ‘instant they are sent by a User 60. Instant Alerts are intended to tell a User(s) of an event in the immediate past. Instant Alerts are viewed immediately by a User from any application the User is engaged in, while the User is logged onto the System. As such, Instant Alerts are transient, except that Instant Alerts are also transmitted as email messages, or other non transient communication mediums to each User who is involved in the Process Step within which the event occurred.

A Web Agents Application, generally designated 156 in FIG. 9O, carries out search activities at block 275 on the WWW 278 relevant to Enterprise and Personal Areas. The Enterprise may have the need to know the latest accepted methods for speech pathology identification, for example. A Web Agent may be established that will automatically update this Folder, such as at block 276, in the Enterprise Area and alert the Users with appropriate permissions that this has occurred. Further, Web Agents may advise Risk Manager and Personal Agent of events on the WWW relative to accomplishment of Performance Goals.

A Messaging Application, generally designated 155 in FIG. 9P, provides a mechanism for non-transient messages to be delivered to each User who is involved in the Process Step within which the event occurred. Each Message is logged into the Repository 55 at block 282 maintaining its association with its particular Process Step Association. Messages are displayed at block 284 on each Users Personal Home Page upon log in.

A Repository Application, generally designated 285 in FIG. 9Q, is a collection of physical data storage locations, e.g., hard disks, and any other data that is organized, but not necessarily structured. Repository Knowledge is accessed through peer-to-peer connections 286, Internet connections 62, Web Drive connections 287 through local devices as organized permanently and temporally by the Method and System. When a User 60 accesses the system via a medium with sufficient support and an application is available either on the server or local machine (actual application and location based on access medium) then the system may launch that application to allow the user to view or manipulate an asset or assets from the repository 55. There is the possibility of launching and manipulating applications, work, and documents in the System Repository and in other data bases 288 that may be relevant to the User.

A System Database, generally designated 290 in FIG. 9R, represents all of the information that the Method needs to present a consistent interpretation of it's′ estate to users. Data may be gathered or delivered at block 294, depending upon the method being performed at block 295 in accordance with the activities being performed at blocks 291-293, to or from the system database 57, including specific databases 57a-57h.

The present invention generally relates to management execution of the process of Transition from the educational system to achievable Performance in adult life. The invention includes methods and systems for forming Transition process teams both ready and able to do their jobs to produce outcomes which will be acceptable to Individuals and Governments involved, while performing the optimal process steps according to a recognized body of knowledge for both performing the steps in the process and gathering and storing results of each step in the process, such as in a computer database, to automate many of the steps of the process.

Automated techniques are used to perform a process in the field of education that has heretofore been manually performed. For example, the system may gather information about the preferences of Individuals (What are the Individuals' life goals) with disabilities, matching preferences with current levels of Performance (How is the individual performing, or likely to perform in areas required to achieve desired preferences), automatically matching and linking new skills and abilities required to achieve individual preferences together with specific reference to resources able to provide experiences, training, education, devices, advice and counseling; and then to automatically generate a detailed time-line showing each step to be performed, how and why it is to be performed, who would be the expected performers, when each step would be performed and tracking and maintaining this information over time including how well each step is performed and the underlying knowledge inherent in and about each step and the individual participants.

For example, the systems and methods of the present invention automate the transition planning process of helping to identify or create and identify the student's preferences, goals, and vision for the future; and based on these preferences, goals and vision, to create a plan of needed supports and services (including supports and services available through community resources) to help meet the student's post-secondary goals and maintain progress towards those goals after the student completes high school. In addition, the systems and methods automatically create a transition plan that includes actionable steps, resources and durations; and enables case managers and other personnel involved with students with disabilities to maintain communications and a real-time view of the students' progress towards accomplishing the students' goals.

The invention described above also provides for a World Wide Web (WWW) based solution to this problem. This is desirable to provide methods and systems for integrating Individual Transition Planning, Transition Process and Knowledge Management, and Individualized Education Programs.

The systems and methods of the present invention have a number of distinct advantages. It links Educational System and Community content to Transition Planning, Execution and Management processes, and events, leverages existing knowledge and content, provides Teams 24/7 access via the Internet, Intranet or Extranet, allows security, encourages creation, maintenance and publishing of content and harnesses and focuses Knowledge Management. There will be increased coordination, lower costs, increased productivity of teams and partners, an audit trail of everything done, best practices development and better relationships among and between participants, and higher consumer satisfaction. There will be:

Individual-focused planning

Individual development, which includes school-based and work-based learning

Interagency and interdisciplinary collaboration

Family involvement

Program structure and attributes that include a range of curricular options that are based on post school goals.

In general terms, the systems and methods of the present invention perform Transition Planning, Execution and Management processes, and other events over the web with management of Tasks, Durations, and Resources. These systems and methods also manage Educational System and Community Knowledge and provide Shared Access to Best Practice Documentation, Organization and Version Control. Further, the systems and methods contextually match work with process steps for increased Productivity, and improved Asset Management. Continuous Performance Improvement also results because the School System builds its own unique capability, captures and maintains every transaction, captures educational and business processes & best practices, and manages workflow among team members, archives best practices for use by new Individuals including both instructions and a clear structure for dynamic process steps. Risk is minimized by matching the right people to the right process with the right information at the right time. Compliance is assured by monitoring and reporting on Service Providers and provided services to and for each individual involved.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims when the claims are properly interpreted and construed.

1. A system for the automated generation of individual transition plans, said system comprising:
a computer database for receiving a student's post school goals, for receiving said student's present levels of performance, for determining the transition services needed to achieve the post school goals, and for generating an individual transition plan.

2. The system for the automated generation of individual transition plans in accordance with claim 1 wherein the student's progress may be analyzed by the computer database against the individual transition plan to provide an updated individual transition plan.

3. The system for the automated generation of individual transition plans in accordance with claim 1 further comprising:
an internet site that is accessible by individuals participating in the individual transition plan; and
said computer database in communication with the internet site to permit information to flow between the database and the individuals participating in the individual transition plan.

4. The system for the automated generation of individual transition plans in accordance with claim 3 further comprising:
a security level that only permits authorized users to have access to said system.

5. The system for the automated generation of individual transition plans in accordance with claim 3 further comprising:
a plurality of system services on said system that are accessible by authorized users, wherein said plurality of system services includes one or more services selected from the group consisting of user management, system search, group/tenant management, security management, area management, web drive and wireless management.

6. The system for the automated generation of individual transition plans in accordance with claim 3 further comprising:
a plurality of system work areas on said system that are accessible by authorized users, wherein said plurality of system work areas includes one or more system work areas selected from the group consisting of enterprise areas, individual areas, user areas and experience areas.

7. The system for the automated generation of individual transition plans in accordance with claim 6 further comprising:
a manager's layer on said system that permits access of certain information in said plurality of system work areas only by authorized managers, wherein said manager's layer includes one or more managers selected from the group consisting of managers of knowledge, managers of teams, managers of process and managers of risk.

8. The system for the automated generation of individual transition plans in accordance with claim 3 further comprising:
a plurality of application services on said system that are accessible by authorized users, wherein said plurality of application services includes one or more application services selected from the group consisting of calendaring, Gantt charts, Email, surveys, discussion groups, personal assistant, version control, work flow, computer based training, lessons learned, individual planning, peer-to-peer messaging, report builder, instant alerts, web agent and experiences.

9. A method for the automated generation of individual transition plans for students in a system that includes a computer database, said method comprising the steps of:
receiving a student's post school goals into the system;
receiving the student's present levels of performance into the system;
automatically determining from the system the transition services that the student needs to achieve the post school goals; and
generating within the system an individual transition plan for said student.

10. The method for the automated generation of individual transition plans for students in a system that includes a computer database in accordance with claim 9, said method comprising the additional steps of:
analyzing the student's progress within the system against the individual transition plan; and
generating within the system an updated individual transition plan.

11. The method for the automated generation of individual transition plans for students in a system that includes a computer database in accordance with claim 9, said method comprising the additional steps of:
providing internet site access to the system for individuals participating in the individual transition plan; and
communicating between the internet site and the computer database to permit information to flow between said database and the individuals participating in the individual transition plan.

12. The method for the automated generation of individual transition plans for students in a system that includes a computer database in accordance with claim 11, said method comprising the additional step of:
using a security level to only permit authorized users to have access to the system.

13. The method for the automated generation of individual transition plans for students in a system that includes a computer database in accordance with claim 11, said method comprising the additional step of:
providing a plurality of system services on said system that are accessible by authorized users, wherein said plurality of system services includes one or more services selected from the group consisting of user management, system search, group/tenant management, security management, area management, web drive and wireless management.

14. The method for the automated generation of individual transition plans for students in a system that includes a computer database in accordance with claim 11, said method comprising the additional step of:
providing a plurality of system work areas on said system that are accessible by authorized users, wherein said plurality of system work areas includes one or more system work areas selected from the group consisting of enterprise areas, individual areas, user areas and experience areas.

15. The method for the automated generation of individual transition plans for students in a system that includes a computer database in accordance with claim 14, said method comprising the additional step of:
providing a manager's layer on said system that permits access of certain information in said plurality of system work areas only by authorized managers, wherein said manager's layer includes one or more managers selected from the group consisting of managers of knowledge, managers of teams, managers of process and managers of risk.

16. The method for the automated generation of individual transition plans for students in a system that includes a computer database in accordance with claim 11, said method comprising the additional step of:
providing a plurality of application services on said system that are accessible by authorized users, wherein said plurality of application services includes one or more application services selected from the group consisting of calendaring, Gantt charts, Email, surveys, discussion groups, personal assistant, version control, work flow, computer based training, lessons learned, individual planning, peer-to-peer messaging, report builder, instant alerts, web agent and experiences.
